(19) United States
(12) Patent Application Publication
(10) Pub. No.: US 2026/0301140 A1
(43) Pub. Date: Oct. 1, 2026

(54) ANALYTIC FOURIER PTYCHOTOMOGRAPHY FOR VOLUMETRIC REFRACTIVE INDEX IMAGING

(71) Applicant: California Institute of Technology, Pasadena, CA (US)

(72) Inventors: Zhenyu Dong, Pasadena, CA (US); Haowen Zhou, Arcadia, CA (US); Ruizhi Cao, El Cerrito, CA (US); Changhuei Yang, South Pasadena, CA (US)

(73) Assignee: California Institute of Technology, Pasadena, CA (US)

(21) Appl. No.: 19/634,673

(22) Filed: Mar. 31, 2026

Related U.S. Application Data
(60) Provisional application No. 63/781,820, filed on Apr. 1, 2025.

(51) Int. Cl. G06T 5/80; G06T 5/10; G06T 5/50; G06T 15/08; G06V 10/141

(52) U.S. Cl. CPC G06T 5/80; G06T 5/10; G06T 5/50; G06T 15/08; G06V 10/141; G06T 2207/20221

(57) ABSTRACT

Analytic Fourier ptychotomography techniques for analytically reconstructing a volumetric (3D) refractive index image based on NA-matching intensity measurements, darkfield intensity measurements, and a finite sample thickness (FST) prior where the FST prior is used for aberration correction and darkfield extension.

### CROSS-REFERENCE TO RELATED APPLICATION

This application claims benefit of and priority to U.S. Provisional Patent Application No. 63/781,820, titled “Analytic Fourier Ptychotomography for Volumetric Refractive Index Imaging,” filed on Apr. 1, 2025, which is incorporated by reference herein in its entirety and for all purposes.

### FIELD

Certain aspects relate generally to tomography, and more specifically to analytic Fourier ptychotomography (AFP) techniques for volumetric (3D) refractive index imaging.

### BACKGROUND

Refractive index (RI) is an intrinsic optical property of an optical medium such a biological or clinical sample. The refractive index of biological and clinical samples can encode their structural composition. For example, a three-dimensional refractive index (3D-RI) distribution (map) of a biological sample can be used to determine structural composition such as cell densities, organelle types, and protein concentrations.

Background and contextual descriptions contained herein are provided solely for the purpose of generally presenting the context of the disclosure. Much of this disclosure presents work of the inventors, and simply because such work is described in the background section or presented as context elsewhere herein does not mean that such work is admitted prior art.

### SUMMARY

Certain techniques disclosed herein may be practiced with a processor-implemented method, a system comprising one or more processors and one or more processor-readable media, and/or one or more non-transitory processor-readable media.

Certain embodiments pertain to analytic Fourier ptychotomography (AFP) imaging methods. In some cases, the AFP imaging methods include obtaining a plurality of NA-matching intensity measurements corresponding to plurality of NA-matching illumination angles and a plurality of darkfield intensity measurements corresponding to a plurality of darkfield illumination angles; determining an aberration-corrected NA-matching spectrum based at least in part on the plurality of NA-matching intensity measurements and a finite sample thickness (FST) prior; extending the aberration-corrected NA-matching spectrum using the plurality of darkfield intensity measurements; and reconstructing a volumetric refractive index distribution of a sample being imaged based at least in part on the extended aberration-corrected NA-matching spectrum.

Certain embodiments pertain to analytic Fourier ptychotomography (AFP) imaging systems. In some cases, the AFP imaging systems include an illumination system configured to provide illumination at a plurality of NA-matching illumination angles and at a plurality of darkfield illumination angles to a sample being imaged, an optical system comprising collection optics configured to collect light scattered by a sample being illuminated, wherein the NA-matching illumination angles are equal to, or nearly equal to, an acceptance angle of the collection optics and the darkfield illumination angles are greater than the acceptance angle of the collection optics; one or more light detectors in optical communication with the optical system, the one or more light detectors configured to acquire (i) a plurality of NA-matching intensity measurements corresponding to the NA-matching illumination angles and (i) a plurality of darkfield measurements corresponding to the darkfield illumination angles; and a computing device configured to reconstruct a volumetric refractive index distribution based at least in part on the plurality of NA-matching intensity measurements and the plurality of darkfield measurements.

Certain embodiments pertain to non-transitory machine-readable medium comprising instructions that, when executed by one or more processors are configured to cause the one or more processors to perform operations. The operations include obtaining a plurality of NA-matching intensity measurements corresponding to plurality of NA-matching illumination angles and a plurality of darkfield intensity measurements corresponding to a plurality of darkfield illumination angles; determining an aberration-corrected NA-matching spectrum based at least in part on the plurality of NA-matching intensity measurements and a finite sample thickness (FST) prior; extending the aberration-corrected NA-matching spectrum using the plurality of darkfield intensity measurements; and reconstructing a volumetric refractive index distribution based at least in part on the extended aberration-corrected NA-matching spectrum. These and other features and embodiments will be described in more detail with reference to the drawings.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 depicts a block diagram of example components of an analytic Fourier ptychotomography (AFP) system, according to various embodiments.

FIG. 2A depicts a schematic diagram of an example of an LED-array analytic Fourier ptychotomography (AFP) system during acquisition of an NA-matching image, according to embodiments.

FIG. 2B depicts a schematic diagram of the LED-array AFP system of FIG. 2A during acquisition of a darkfield image.

FIG. 3A depicts a schematic diagram of an LED disk during NA-matching illumination, according to embodiments.

FIG. 3B depicts a schematic diagram of the LED disk in FIG. 3A during darkfield illumination, according to embodiments.

FIG. 4 is a photograph of a bottom view of an LED disk, according to an embodiment.

FIG. 5 is a photograph of an LED-array AFP system that includes a commercialized microscope body, according to an embodiment.

FIG. 6 is a photograph of components of the LED-array AFP system of FIG. 5.

FIG. 7 depicts a schematic diagram of a laser-based analytic Fourier ptychotomography (AFP) system, according to an embodiment

FIG. 8 depicts a schematic diagram of a rotating LED analytic Fourier ptychotomography (AFP) system, according to embodiments.

FIG. 9 is a schematic diagram illustrating an overview of an example of a raw image acquisition step and an analytic reconstruction step of the AFP method, according to embodiments.

FIG. 10 is a schematic diagram depicting an overview of an example of an analytic NA-matching spectrum recovery procedure, according to embodiments.

FIG. 11 is a schematic diagram depicting an overview of an example of an analytic aberration correction procedure, according to embodiments.

FIG. 12 is a schematic diagram depicting an overview of an example of an analytic spectrum extension procedure, according to an embodiment.

FIG. 13 depicts a schematic illustration of extended overlaps with and without FST prior, according to embodiments.

FIG. 14 depicts a flow diagram of an example of operations of an AFP method, according to various embodiments.

FIG. 15 depicts a flow diagram of an example of certain suboperations of the AFP method in FIG. 14, according to an embodiment.

FIG. 16 depicts a flow diagram of an example of certain suboperations of the AFP method in FIG. 14, according to an embodiment.

FIG. 17 depicts a flow diagram of an example of certain suboperations of the AFP method in FIG. 14, according to an embodiment.

FIG. 18 depicts a flow diagram of an example of certain suboperations of the AFP method in FIG. 14, according to an embodiment.

FIG. 19 depicts a flow diagram of an example of certain suboperations of the AFP method in FIG. 14, according to an embodiment.

FIG. 20 depicts simulated 3D-RI AFP images and ground truth images of a 6-μm polystyrene bead, according to implementations.

FIG. 21 depicts illustration of comparison between aberrations reconstructed by AFP and ground truth images, obtained while imaging a 6-μm polystyrene bead obtained while imaging a 6-μm polystyrene bead, according to implementations.

FIG. 22 depicts experimental 3D-RI AFP images of a 6-μm polystyrene bead with defocus system aberration, according to implementations.

FIG. 23 depicts experimentally-derived 3D-RI AFP images of sample with spherically-dominant aberration, according to implementations.

FIG. 24 depicts experimentally-derived 3D-RI AFP images of sample with random system aberration, according to implementations.

FIG. 25A depicts a pupil function and Zernike decompositions from AFP reconstruction for the defocus-dominant system aberration depicted in FIG. 22, according to an implementation.

FIG. 25B includes pupil function and Zernike decompositions from AFP reconstruction for the spherical aberration-dominated system depicted in FIG. 23, according to an implementation.

FIG. 25C includes pupil function and Zernike decompositions from AFP reconstruction for the random system aberration depicted in FIG. 24, according to an implementation.

FIG. 26A includes a 3D-RF AFP image of a four-cell stage embryo imaged with the laser-based AFP system, according to an implementation.

FIG. 26B includes visualizations of four z-slices of the 3D-RF AFP image in FIG. 26A, and enlarged views.

FIG. 27 includes a 3D-RF AFP image of an eight-cell stage embryo imaged with the laser-based AFP system, visualizations of three z-slices, according to an implementation.

FIG. 28 includes an illustration of a darkfield extended reconstruction, an illustration of an NA-matching reconstruction for comparison, enlarged views, and a visualization of a comparison between AFP imaging and absorption-based widefield microscope, according to an implementation.

FIG. 29 depicts a maximum intensity projection (MIP) 2D image of a plant root using AFP method, a 3D MIP rendering, and a 3D root skeleton image, according to an implementation.

FIG. 30 depicts images of z-slices of cellular structures from cortex regions in FIG. 29. according to an implementation.

FIG. 31A depicts images of a baby plant root without aberration correction, with aberration correction, and with darkfield extension, according to an implementation.

FIG. 31B depicts a visualization of field-dependent aberration correction for different patches of root structures, and visualization of retrieved aberrations, according to an implementation.

FIG. 32 depicts MIP images of root hair and bacteria, MIP of fluorescence images for bacteria in the same FOV, and more FOVs for overlayed root hair, according to an implementation.

FIG. 33 depicts an z-slice mage of a 20-μm thick human gastric adenocarcinoma cancer pathological slide, according to an implementation.

FIG. 34 depicts an absorption image of the 20-μm thick human gastric adenocarcinoma cancer pathological slide, according to an implementation.

FIG. 35 depicts a widefield microscope image of an H&E-Stained adjacent thin cut and retrieved aberrations, according to an implementation.

FIG. 36 depicts visualizations of examples of image clarity improvements with aberration correction, according to an implementation.

FIG. 37 depicts line profile comparison with and without aberration correction, according to an implementation.

FIG. 38 depicts a block diagram of an example of a computing device, according to various embodiments.

FIG. 39 depicts a block diagram of an example of a computing device, according to various embodiments.

FIG. 40 depicts schematic illustrations of overlaps of 3D spectrum (FST regions) for different sample thicknesses, according to embodiments.

The figures and components therein may not be drawn to scale.

### DETAILED DESCRIPTION

Different aspects are described below with reference to the accompanying drawings. In the following description, numerous specific details are set forth in order to provide a thorough understanding of the presented embodiments. The disclosed embodiments may be practiced without one or more of these specific details. In other instances, well-known operations have not been described in detail to avoid unnecessarily obscuring the disclosed embodiments. While the disclosed embodiments will be described in conjunction with the specific embodiments, it will be understood that it is not intended to limit the disclosed embodiments.

### I. Introduction

Three-dimensional (3D) refractive index (RI) imaging or (RI) tomography offers label-free, quantitative volumetric imaging capable of elucidating biological structures at high resolution. Unlike traditional through-focus scanning methods, which acquire qualitative absorption or phase contrast images layer by layer and stack the images, RI tomography can computationally reconstruct a volumetric refractive index image (three-dimensional refractive index (3D-RI) distribution) of a sample from multiple intensity measurements taken at different illumination angles at one or more planar light detectors. This use of angular illumination eliminates the need for precise and repeatable axial mechanical scanning and, thus, significantly improves system robustness and reduces acquisition time. Moreover, unlike fluorescence microscopy which can induce phototoxicity, RI tomography requires simpler sample preparation and is a better fit for living samples that do not tolerate phototoxicity.

However, conventional RI tomography approaches are limited by optical aberrations, limited resolution, and/or computational complexity. For example, optical diffraction tomography utilizes high-coherence lasers and interferometric measurements to obtain complex light fields, enabling 3D-RI imaging. However, an interferometric setup results in complicated system configurations, and the use of high-coherence lasers are associated with speckle noise. For example, techniques such as 3D differential phase contrast microscopy, intensity diffraction tomography, and low coherence holotomography utilize transfer function theory alongside deconvolution methods to reconstruct RI volumes without the use of interferometric setups. However, these methods require careful parameter tuning and regularization to obtain reliable RI reconstructions. Similarly, optimization-based methods, such as multi-slice and multi-layer Born, are sensitive to initial conditions, require precise parameter selection, and are computationally demanding. Some analytic methods based on the Kramers-Kronig (K-K) relation have been proposed for 3D-RI imaging, leveraging either numerical aperture (NA)-matching illuminations or a combination of through-focus and multi-angle brightfield acquisitions, to enable improved reconstruction stability. However, these analytic methods either suffer from limited axial resolution or require axial scanning and significantly more measurements.

Two challenges persist with conventional RI tomography microscopy approaches: limited resolution and optical aberrations. Resolution in optical microscopy is fundamentally limited by the finite numerical aperture (NA) of the objective lens, which restricts access to high spatial frequencies. Fourier ptychographic diffraction tomography (FPDT), which is derived from Fourier ptychographic microscopy in two-dimensional (2D) imaging, has attempted to address this limitation. It reconstructs the complex light field by numerically stitching together sample's spectra from multi-angle illuminations, including darkfield images that capture frequencies beyond the NA cutoff. However, conventional FPDT approaches still rely on iterative optimization techniques, inheriting the limitations of optimization-based methods. Generally speaking, optimization-based methods are limited in that they require precise parameter selection, and are computationally demanding. The second major challenge is optical aberration, which can result from imperfections in optical elements (particularly at certain wavelengths such as ultraviolet), system misalignment, and sample RI mismatches. These imperfections can distort the original wavefronts of the light and degrade the image quality. Conventional approaches to digital aberration correction are either restricted to 2D thin samples or require parameter tuning and might be sensitive to initial conditions.

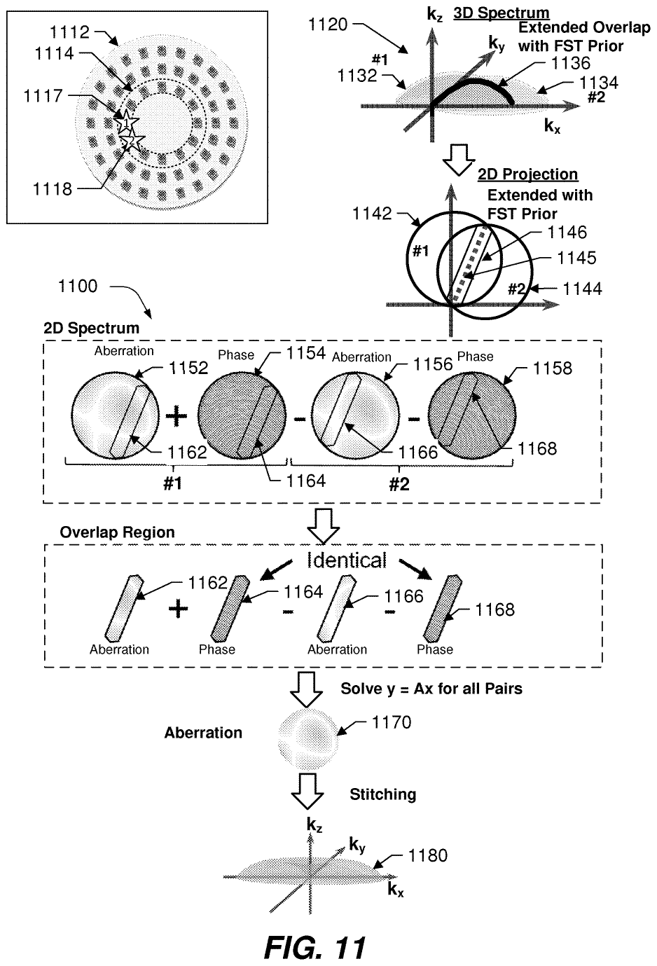

Various embodiments pertain to analytic Fourier ptychotomography (AFP) techniques that can be used to analytically reconstruct complex-valued, darkfield-extended, aberration-corrected 3D tomographic RI images (sometimes referred to herein as “3D-RI AFP images”) of samples such as biological and clinical samples. AFP techniques use a finite sample thickness (FST) as prior knowledge (referred to herein as “FST prior”) to expand the sub-spectra (from different illumination angles) overlap. An example of an extended overlap region 1146 is schematically depicted in FIG. 11. Using the FST prior turns the reconstruction of the 3D-RI images into a solvable linear set of equations (discussed in Section III). This allows for aberration correction and darkfield extension to be treated as linear problems that can be solved analytically. As used herein, an “FST prior” refers to that a 3D sample of interest is limited in its thickness, which implies that the 3D Fourier spectrum of such 3D sample must be locally correlated along the k_{z} axis, and the strength of correlation depends on the sample thickness. Without such prior, we could only sample the top spherical cap of the Ewald sphere, and this prior knowledge effectively expands that cap along the k_{z} axis, thereby enhancing correlations between adjacent sub-spectra as well as between brightfield and darkfield spectra. Specifically, FST prior is used in AFP for aberration correction to expand reliable overlap region and in darkfield extension to find the known spectrum region.

In various embodiments, AFP techniques reconstruct the complex optical fields from NA-matching intensity measurements using the Kramers-Kronig (K-K) relation. These AFP techniques analytically correct for system aberrations from NA-matching sub-spectrum overlaps and extend the sample spectrum (using darkfield measurements) beyond the system's physical limits in 3D, while leveraging the finite sample thickness (FST) prior which simplifies the inverse scattering problem by linearizing the problem. AFP techniques enable rapid imaging by eliminating axial scanning, and employ an all-analytic technique that removes the need for manual parameter tuning. These AFP techniques increase space-bandwidth product of the imaging system, achieve large field-of-view (FOV), subcellular resolution, and retain a long working distance. The simplicity, robustness and efficiency of AFP techniques make them a powerful and user-friendly tool for quantitative volumetric RI imaging.

AFP systems (also referred to as “AFP imaging systems”) of certain embodiments were used to generate complex-valued, darkfield-extended, aberration-corrected, volumetric refractive index images (sometimes referred to herein generally as “3D-RI AFP images”) of polystyrene beads under various kind of aberration conditions, mouse embryos, plant roots, bacteria, and biological tissue samples. The experimental results are provided in Section IV. These results demonstrate that AFP techniques have broad applicability across diverse fields, including embryo imaging, plant root and bacteria analysis, and 3D digital pathology.

AFP techniques of various embodiments may provide one or more advantages over conventional RI tomography. For example, AFP techniques may simplify hardware requirements for acquiring RI information over conventional RI tomography techniques by using multi-angle illumination on the sample, eliminating the need for high-precision axial scanning equipment. For example, certain conventional RI tomography techniques require mechanical scanning to take measurements at different planes and stacking 2D images. AFP techniques advantageously use multi-angle illumination and acquire 2D measurements at planar sensor(s). AFP techniques also employ a robust and analytic reconstruction method that enhances both reconstruction efficiency and performance. Unlike traditional iterative reconstruction methods-which are error-prone, parameter-sensitive and non-generalizable, AFP methods do not require manual parameter tuning and computationally intensive optimizations. Additionally, AFP methods can analytically correct for system aberrations, significantly improving image quality and clarity. For example, in some cases, AFP methods can analytically solve for system aberrations and analytically remove the aberrations. Furthermore, AFP methods feature analytic Fourier spectrum extension capability, which can provide a two-fold enhancement in spatial resolution across three dimensions. Unlike traditional iterative reconstruction methods, AFP methods analytically extend the Fourier spectrum based on dark field measurements. In some embodiments, AFP methods integrate spectrum extension, aberration correction, and analytical reconstruction in a single approach for reconstruction of 3D-RI distributions.

Analytic Fourier ptychotomography methods for volumetric refractive index imaging (referred to as “AFP methods” or “AFP imaging methods”) can be used to analytically reconstruct complex-valued, darkfield-extended, aberration-corrected, volumetric refractive index images (sometimes referred to herein generally as “3D-RI AFP images”) of a sample being imaged. Generally speaking, AFP methods include a raw image acquisition step and an analytic reconstruction step that includes an NA-matching spectrum recovery procedure to generate a plurality of NA-matching spectrum, an analytic aberration correction procedure to generate an aberration-corrected NA-matching sample spectrum, and an analytic spectrum extension procedure to extend the sample aberration-corrected NA-matching sample spectrum using the darkfield measurements and reconstruct the 3D-RI AFP image. During the raw image acquisition step, a plurality of NA-matching intensity measurements and a plurality of darkfield measurements of a sample are obtained. For example, an illumination system may deliver illumination at different NA-matching illumination angles and different darkfield illumination angles to the sample being imaged and raw intensity measurements (images) are captured sequentially based in part on scattered light from the sample. NA-matching illumination angles are equal to, or nearly equal to, a maximum acceptance angle of the collection optics of the imaging system. Darkfield illumination angles are greater than a maximum acceptance angle of the collection optics. The AFP method analytically recovers a plurality of NA-matching sub-spectrums (spectra) from the plurality of NA-matching measurements using the Kramers-Kronig (K-K) relation. The AFP method solves for system aberration using the FST prior and removes the system aberration to form an aberration-corrected NA-matching 3D sample spectrum. The AFP method extends the aberration-corrected NA-matching 3D sample spectrum using the spectra from the darkfield measurements to form an extended sample spectrum. The AFP method reconstructs a complex-valued, darkfield-extended, aberration-corrected, volumetric refractive index image (3D-RI AFP image) from the extended sample spectrum.

According to various embodiments, AFP systems include multi-angle illumination systems for delivering multi-angle illumination to a sample being imaged and an optical system for collecting scattered light from the specimen. Multi-angle illumination includes sequential illumination at different NA-matching illumination angles and different darkfield illumination angles. AFP systems also include one or more light detectors for capturing a plurality of NA-matching intensity measurements (raw NA-matching images) and a plurality of darkfield intensity measurements (raw darkfield images). AFP systems may also include a computing device for performing system operations such as AFP reconstruction.

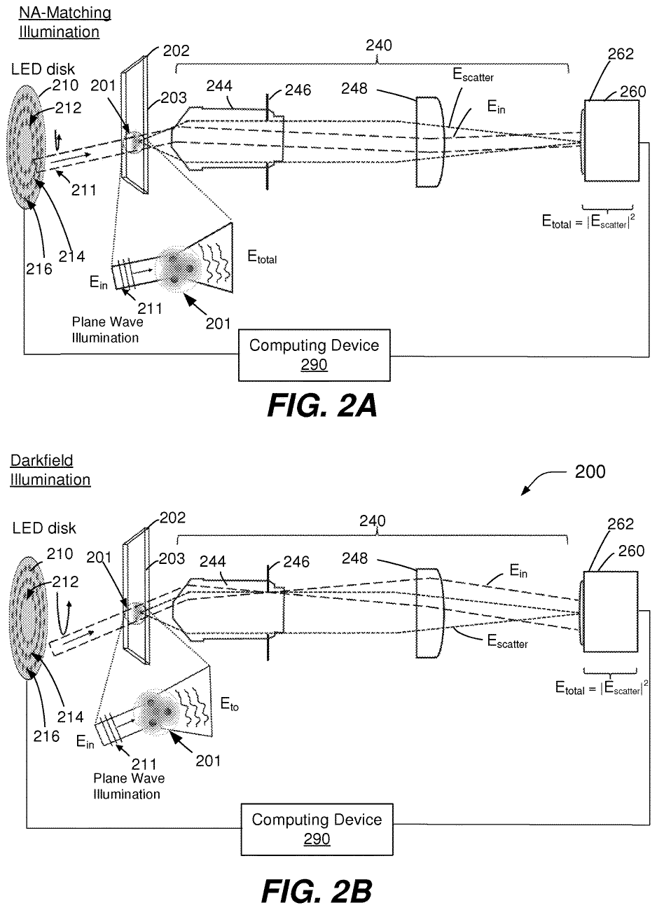

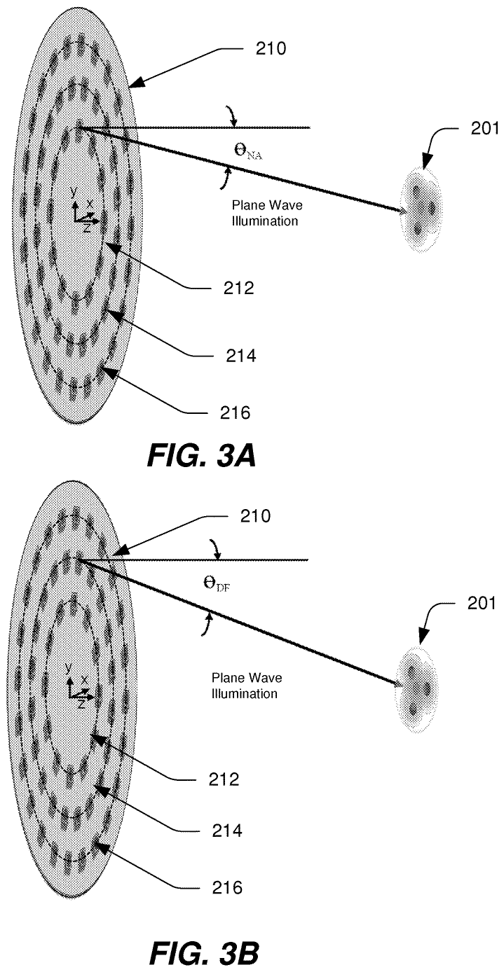

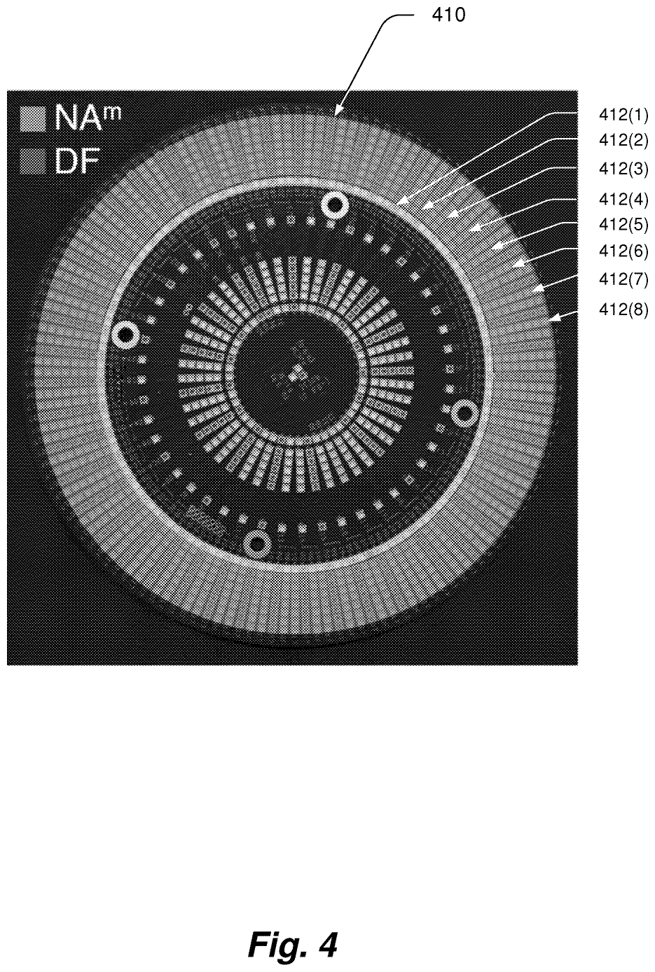

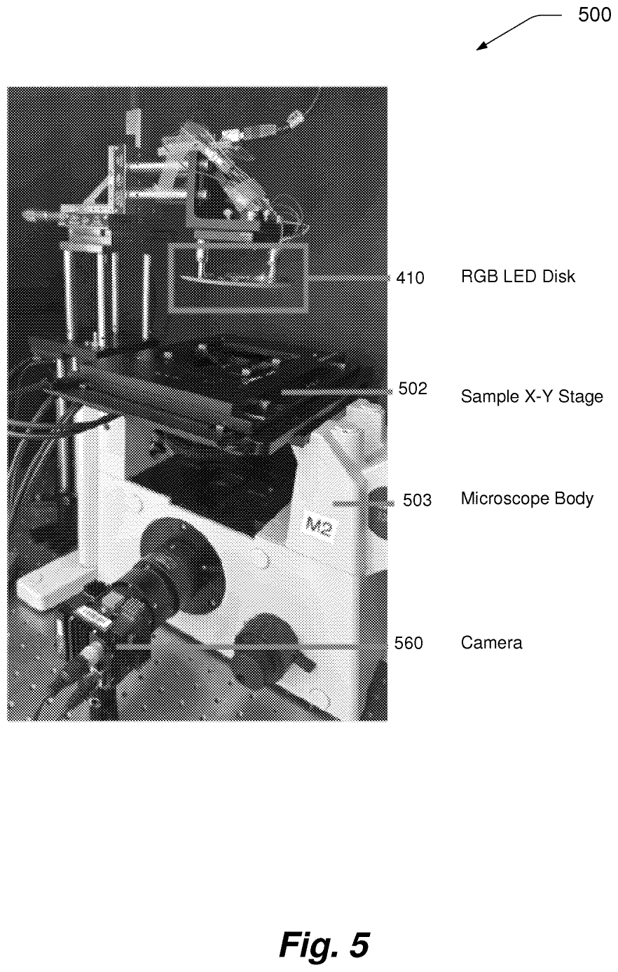

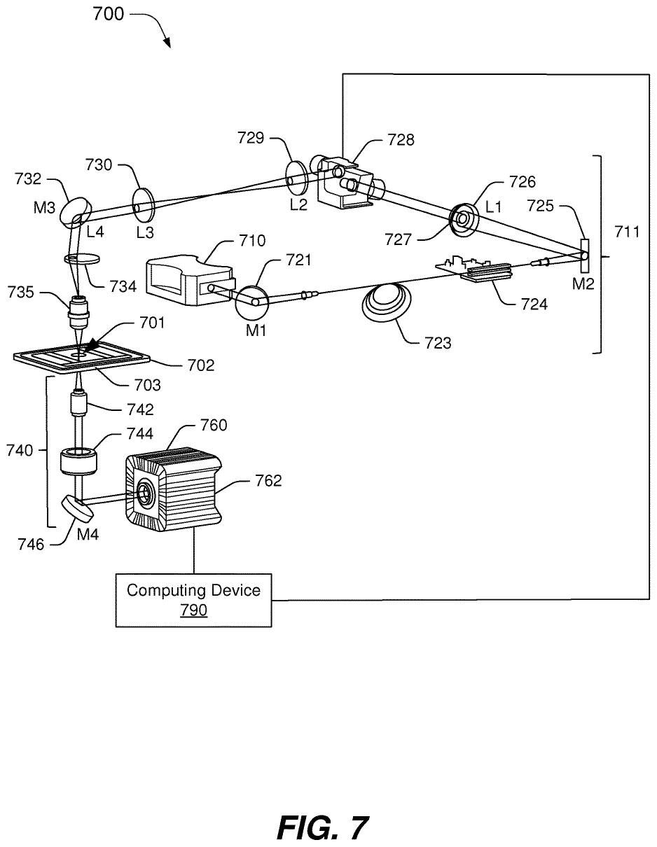

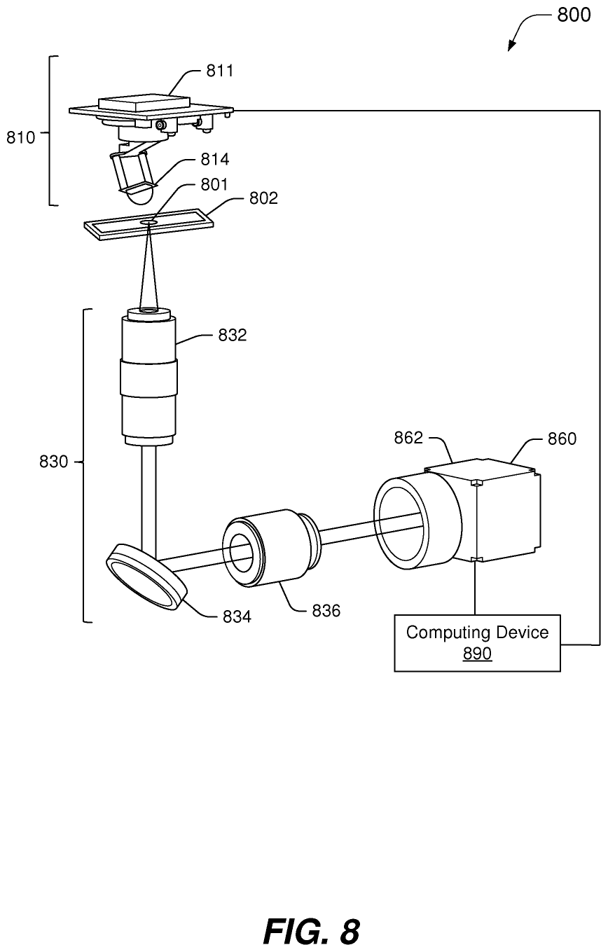

According to various embodiments, AFP systems may include different configurations of multi-angle illumination systems. Some examples of multi-angle illumination systems that may be used include a galvo-mirror scanning system with a laser source or a light emitting diode (LED), a programmable LED array, a single LED mounted on a rotational stage. For example, in one embodiment, an AFP system may implement a multi-angle illumination system having a laser source (e.g., laser source 710 in FIG. 7) and a pair of galvo mirrors (e.g., galvo mirror pair 728 with 2-axis galvo mirrors in FIG. 7) for directing a laser beam at different illumination angles. In another embodiment, an AFP system may implement an illumination system having an LED array. An example of such an LED array is an LED disk (e.g., LED disk 210 in FIGS. 2A and 2B, LED disk 310 in FIGS. 3A and 3B, LED disk 410 in FIG. 4, and LED disk 510 in FIG. 5) having one or more circular arrangements (sometimes referred to herein as “rings”) of LEDs. In other embodiments, an AFP system may implement an illumination system having a single illumination source such as an LED (e.g., LED 814 in FIG. 8) mounted on a rotational mechanism (e.g., rotational stage 811 in FIG. 8). In some cases, the multi-angle illumination systems may enable programable control of illumination angles. For example, certain AFP systems may include a computing device (e.g., including a controller) that can send control signals to one or more components of the illumination systems to cause the activation of light source(s) and/or cause movement (e.g., rotation) of one or more mechanisms or motors (e.g., motorized galvo mirrors, rotational state, one or more X-Y stages, a motor, etc.) to control illumination angles.

The ability of AFP techniques to map a 3D-RI distribution of a sample makes it well-suited for quantitative analysis of weak scattering microscopic samples, such as polystyrene beads, embryos, plant roots, bacteria, pathology slides, algae, live cells and organoids. AFP techniques are particularly suitable for imaging living samples that do not tolerate phototoxicity well, such as live embryos. The simplicity, robustness and label-free nature of AFP techniques make them an attractive imaging technology for quantitative 3D analysis in biological, microbial ecological, and medical studies.

### II. Analytic Fourier Ptychotomography (AFP) Systems

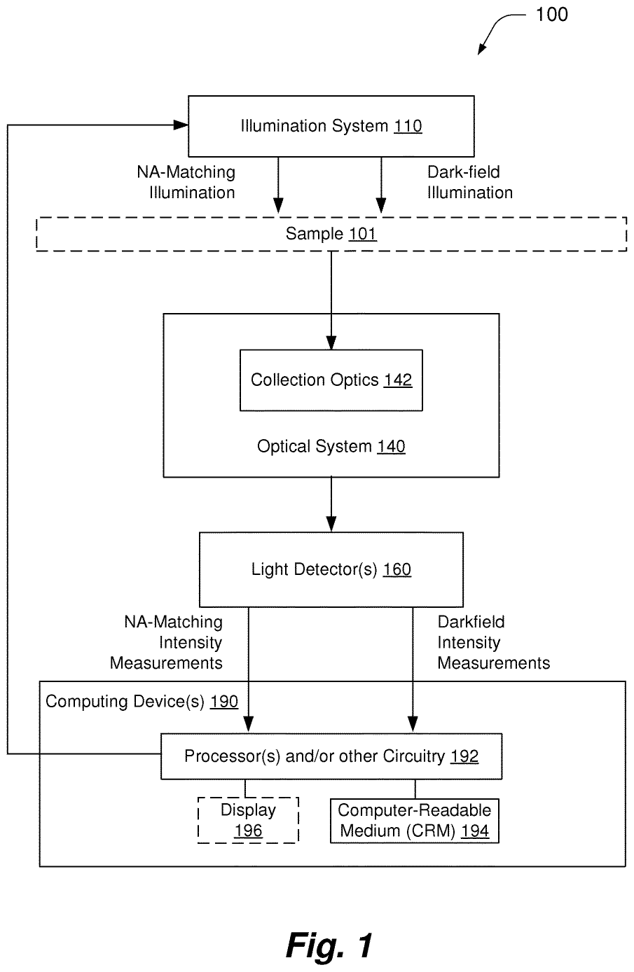

FIG. 1 is a block diagram of example components of an analytic Fourier ptychotomography (AFP) system 100, according to various embodiments. The AFP system 100 includes an illumination system 110 configured to provide NA-matching illumination at a plurality of NA-matching illumination angles and dark-field illumination at one or more dark-field illumination angles sequentially at different sample times to a sample 101 being imaged. The AFP system 100 is shown at an instant when the sample 101 is being imaged. It would be understood that the presence of a sample 101 is optional (denoted by a dotted line). The illumination system 110 may be configured to provide illumination in reflection mode and/or in transmission mode. The AFP system 100 also includes an optical system 140 in optical communication with the sample 101, one or more light detectors 160 in optical communication with the optical system 140, and one or more computing devices 190 in electronic communication with the one or more light detectors 160 and the illumination system 110. Further, it should be noted that the AFP system 100 of other implementations may include additional or fewer components than those depicted in FIG. 1.

The optical system 140 includes collection optics 142 such an objective lens (e.g., lens of objective 224 in FIGS. 2A and 2B) for receiving light scattered by the sample 101. Some examples of objectives that can be used include a 20× magnification, 0.40 NA objective (e.g., Plan N 20×/0.40 NA objective sold by Olympus), a 20× magnification, 0.37 NA objective (e.g., Infinity Corrected 20×/0.37 NA objective sold by Mitutoyo), or a 10× magnification, NA 0.25 objective, (e.g., 10× magnification, NA 0.25 objective sold by Olympus). The collection optics 142 has a numerical aperture (NA) and is configured to accept light within its maximum acceptance angle associated with its NA. The optical system 140 may include additional optical elements (e.g., mirror(s), beam splitter(s), optical fiber(s), lens(es), etc.) for propagating light to the light detector(s) 160.

As used herein, “NA-matching illumination angles” can refer to illumination angles that are equal to, or nearly equal to (e.g., within 2%, within 1%, etc.), the maximum acceptance angle of the collection optics of the AFP system being implemented. As used herein, “darkfield illumination angles” can refer to illumination angles that are greater than the maximum acceptance angle of the collection optics of the AFP system being implemented.

In FIG. 1, the illumination system 110 is configured to provide NA-matching illumination at NA-matching illumination angles that equal to, or nearly equal to, the acceptance angle of the collection optics 142. The illumination system 110 is also configured to provide dark-field illumination at one or more dark-field illumination angles that are greater than acceptance angle of the collection optics 142. The illumination system 110 may include one or more components for delivering illumination from one or more illumination sources (e.g., (e.g., light-emitting diodes LEDs, laser source(s), etc.) to the sample 101 according to the different illumination angles. For example, the illumination system 110 may include one or more optical component components (e.g., mirror(s), beam splitter(s), optical fiber(s), lens(es), etc.) to propagate light. The illumination system 110 may include one or more components for changing the illumination angle such as translational stage(s), rotational stage(s), etc. In some cases, the AFP system 100 may include components that enable programmable control of illumination angles. For example, the computing device(s) 190 (e.g., system including a controller) may be configured to send control signals to the illumination system 110 to cause sequential activation of illumination source(s) and/or cause movement (e.g., rotation) of a mechanism (e.g., motorized galvo mirrors, rotational stage, one or more X-Y stages, etc.) to control illumination angles.

The AFP system 100 also includes one or more light detectors 160 in optical communication with the optical system 140 to receive light scattered by the sample 101 and other unscattered light. During image acquisition, the incident planewave from the illumination source(s) interact with a weakly scattering sample. The total optical field, containing both the unscattered and scattered light, is then captured by the light detector(s) 160 (e.g., a camera) and only the intensities are recorded in the image measurements. The one or more light detectors 160 are configured to sequentially acquire a plurality of NA-matching intensity measurements while the illumination system 110 provides illumination at NA-matching illumination angles and sequentially acquire one or more darkfield intensity measurements while the illumination system 110 provides illumination at darkfield illumination angles. The measurements may be acquired in any order. The light detector(s) 160 (e.g., a complementary metal-oxide-semiconductor (CMOS) camera or a scientific complementary metal-oxide-semiconductor (sCMOS) camera) are configured to be sensitive to the wavelength of electromagnetic energy emitted by the illumination source(s).

The computing device(s) 190 include one or more processors 192 and/or other circuitry, a non-transitory computer readable medium (CRM) 194, and an optional (denoted by dashed line) display 196. The processor(s) 192 are in electrical communication with one or more light detectors 160 to receive signals with NA-matching intensity measurements and one or more darkfield intensity measurements and/or to send control signals to the one or more light detectors 160, for example, to trigger image acquisition. The processor(s) 192 are also in electrical communication with the illumination system 110 to send control signals to control the illumination angles of the NA-matching illumination dark-field illumination. Communication between one or more system components may be in wired and/or wireless form.

According to various embodiments, an AFP system may implement different configurations of illumination systems. For example, in some embodiments, the illumination system may include a light-emitting diode (LED) array that may be programmable to provide illumination at different illumination angles that are propagated to the sample to illuminate the sample at corresponding incidence angles. The LED arrays may include different arrangements of LEDs. An example of a suitable LED array is an LED disk (e.g., LED disk 210 in FIGS. 2A and 2B, LED disk 310 in FIGS. 3A and 3B, LED disk 410 in FIG. 4, and LED disk 510 in FIG. 5) having one or more circular arrangements (sometimes referred to herein as “rings”) of LEDs. In other embodiments, a rectangular LED array with one or more rectangular arrangements may be used. In some embodiments, the illumination system may have a single LED (e.g., LED 814 in FIG. 8) mounted on a rotational mechanism (e.g., rotational stage 811 in FIG. 8). In some embodiments, the illumination system may include a laser source (e.g., laser source 710 in FIG. 7) and a plurality of galvo mirrors (e.g., galvo mirror pair 728 with 2-axis galvo mirrors in FIG. 7) for directing a laser beam from the laser source at different illumination angles incident the sample.

In some embodiments, the illumination system includes one or more illumination sources. In other cases, illumination system is in communication with (e.g., via optical fibers) the one or more external illumination sources to receive illumination. For example, the illumination system 110 in FIG. 1 may receive a laser beam from one or more external laser sources (e.g., via optical fibers) that are separate from the illumination system 110 and/or the AFP system 100. The illumination source(s) provide electromagnetic waves of various wavelength according to various embodiments. In some cases, the illumination source(s) provide wavelength within the visible spectrum. In some cases, the illumination source(s) provide electromagnetic waves in the ultraviolet spectrum such as a deep ultraviolet spectrum (e.g., 265 nm). In some cases, the illumination source(s) provide electromagnetic waves in the infrared spectrum. In some cases, the illumination source(s) provide plane-wave illumination.

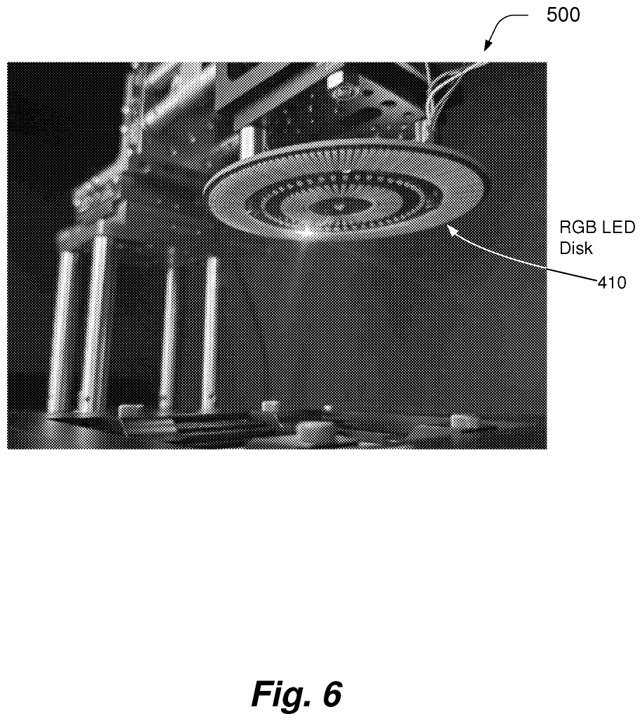

In some embodiments, the illumination system includes a first plurality of NA-matching illumination sources configured to provide illumination sequentially at a corresponding plurality of NA-matching illumination angles for acquiring a plurality of NA-matching measurements and a second plurality of darkfield illumination sources configured to provide illumination sequentially at a corresponding plurality of darkfield illumination angles for acquiring a plurality of darkfield measurements. For example, the illumination system may be in the form of an LED disk (e.g., LED disk 210 in FIGS. 2A and 2B, LED disk 310 in FIGS. 3A and 3B, LED disk 410 in FIG. 4, LED disk 510 in FIG. 5, and LED disk 610 in FIGS. 6 and 6) having one or more rings (circular arrangements) of NA-matching illumination sources and one or more rings of darkfield illumination sources. During operation, the computing device may send control signals that sequentially activate the NA-matching illumination sources in one of the rings that corresponds to the NA and acceptance angle of the collection optics. This enables the AFP system to be adjusted for different collection optics being implemented. As another example, the illumination system may be in the form of a rectangular array of illumination sources such as a rectangular LED array (e.g., RGB LED Matrix sold by Adafruit). As another example, an LCD pixel array and/or LCD pixel ring may be used.

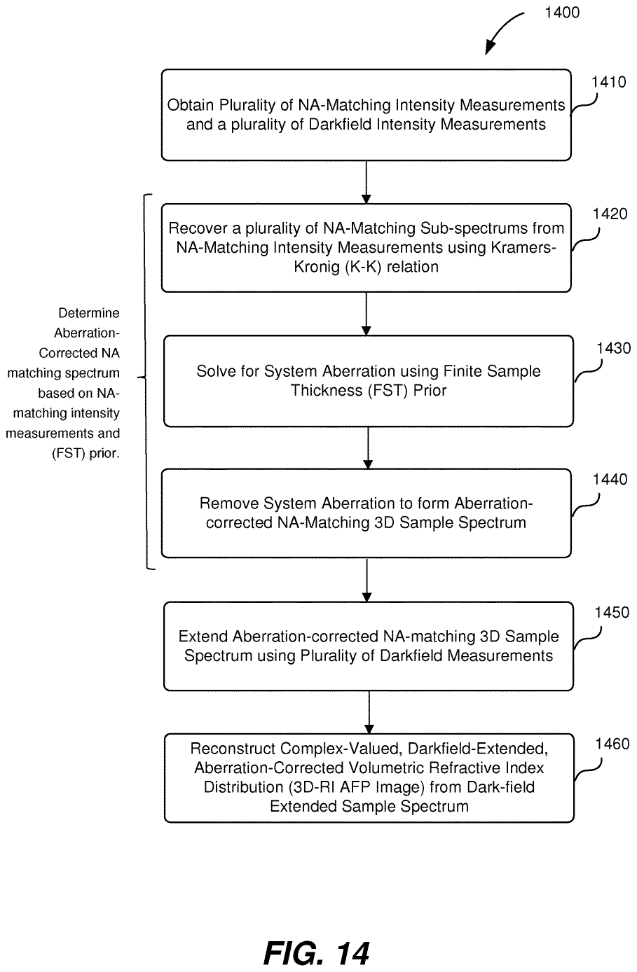

In various embodiments, an AFP system include a computing device (e.g., computing device 190 in FIG. 1, computing device 290 in FIGS. 2A and 2B, computing device 790 in FIG. 7, computing device 890 in FIG. 8) for performing one or more functions of the AFP system such as one or more operations of an AFP method (e.g., AFP methods depicted in FIGS. 14-19). According to various embodiments, a computing device is configured to perform one or more of: (a) obtaining a plurality of NA-matching intensity measurements and a plurality of darkfield intensity measurements, (b) recovering a plurality of NA-matching sub-spectrums from the NA-matching intensity measurements, (c) determining a finite sample thickness (FST) prior, (d) solving for system aberration using the FST prior, (e) remove the system aberration from each of the NA-matching sub-spectrums, (f) stitching together aberration corrected sub-spectrums to form aberration-corrected NA-matching 3D sample spectrum (g) extend aberration corrected NA-matching 3D sample spectrum using darkfield measurements, and (h) reconstructing a volumetric refractive index distribution from darkfield extended sample spectrum.

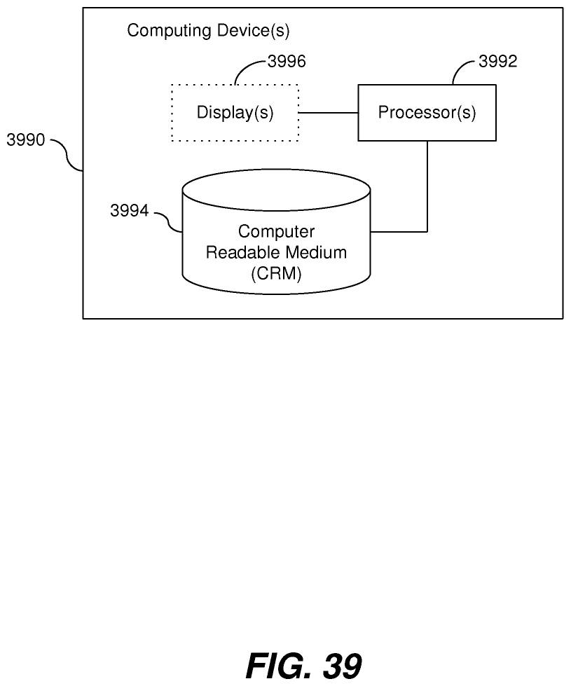

In various embodiments, the computing device includes one or more processors (e.g., processor(s) 192 in FIG. 1, processor(s) 3992 in FIG. 39) and non-transitory computer readable medium (CRM) such as memory (e.g., computer readable medium 184 in FIG. 1 and CRM 3994 in FIG. 39) in communication with the processor(s). Optionally, the computing device may also have a display that is in electrical communication with the one or more processors. The computing device can be in various forms such as, for example, a smartphone, laptop, desktop, tablet, etc. An example of a suitable computing device is a personal computer having a non-transitory computer readable medium. In some cases, the computing device may include or be part of a controller. The processor-executable code (or “instructions”) for performing AFP methods described herein can be stored on the CRM or other memory. The processor(s) and can retrieve the processor-executable code from the CRM or other memory to perform various functions or operations of the AFP methods. The CRM or other memory can store raw and/or processed image data. In some implementations, the CRM or other memory can additionally or alternatively include a volatile memory array for temporarily storing code to be executed as well as image data to be processed, stored, or displayed.

In some embodiments, the computing device of an AFP system may include a controller for controlling functionality of the AFP system. In one example, the controller may include one or more circuit boards (e.g., Arduino board made by Arduino Uno). In one implementation, a first plurality of illumination sources configured to provide illumination sequentially at a corresponding plurality of NA-matching illumination angles for acquiring a plurality of NA-matching measurements are controlled by a first circuit board and the second plurality of illumination sources configured to provide illumination sequentially at a corresponding plurality of darkfield illumination angles for acquiring a plurality of darkfield measurements are controlled by a second circuit board.

In some embodiments, an AFP system has one or more motorized stages upon which one or more components of the AFP system are mounted to adjust the translational position and/or rotational orientation. For example, an AFP system may include a motorized rotational stage (e.g., rotational stage 811 in FIG. 8) upon which an illumination source (e.g., LED 814 in FIG. 8) is mounted to adjust the orientation of the illumination to enable providing illumination at different illumination angles. In some cases, the motorized transitional stage(s) is in communication with the computing device of the AFP system to control illumination angles. In one implementation, two motorized transitional stages are used. In this implementation, two circuit boards (e.g., circuit boards made by Arduino Uno) may be in communication with the motorized transitional stages respectively to control them individually.

### 1) Example LED-Array AFP System

FIG. 2A depicts a schematic diagram of an LED-array analytic Fourier ptychotomography (AFP) system 200, according to embodiments. FIG. 2A depicts the LED-array AFP system 200 during acquisition of an NA-matching intensity measurement (NA-matching image). FIG. 2B depicts a schematic diagram of the LED-array AFP system 200 of FIG. 2A during acquisition of a darkfield intensity measurement (darkfield image). The LED-array AFP system 200 includes an illumination system having a programmable LED array in the form of an LED disk 210. Any suitable wavelength may be used. In one example, the LEDs of the LED disk 210 provide a central wavelength of 520 nm. In other implementations, other types of LED arrays and/or other wavelengths may be used. For example, in one implementation, a rectangular LED array may be used.

The LED disk 210 includes a circular arrangement (ring) of NA-matching LEDs 212 (NA-matching ring), a first ring of darkfield LEDs 214 (first darkfield ring), and a second ring of darkfield LEDs 216 (second darkfield ring). The NA-matching ring 212 (NA-matching ring) is configured to provide NA-matching illumination at a plurality of corresponding NA-matching illumination angles, each LED in the ring operable to provide illumination from a different one of the NA-matching illumination angles. The first darkfield ring 214 and second darkfield ring of can provide darkfield illumination at a plurality of darkfield illumination angles, each LED in each ring operable to provide illumination from a different one of the NA-matching illumination angles. For illustration purposes, the NA-matching ring 212 is shown with 12 LEDs, the first darkfield ring 214 is shown with 20 darkfield LEDs, and the second darkfield ring 216 is shown with 24 LEDs. In other implementations, other numbers of LEDs may be included in each ring and additional or fewer rings may be included. For example, in an alternative embodiment, the LED disk 210 of each ring includes at least 48 LEDs and one or more additional darkfield rings (e.g. 6 additional rings). It would be understood, that not all of the LEDs may be implemented during image acquisition.

In FIG. 2B, the LED-array AFP system 200 is shown at an instant when a raw darkfield image of a sample 201 disposed on a sample receptacle 202 (e.g., glass slide) is being acquired. The sample receptacle 202 was mounted to a motorized translation stage 203 (e.g., MLS203-1 translational stage sold by Thorlabs) for scanning samples laterally to image across large sample areas in large FOV scanning implementations. In other implementations, the motorized stage may be omitted. In FIG. 2B, the LED-array AFP system 200 is shown at an instant when a raw darkfield image of a sample 201 is disposed on a sample receptacle 202 (e.g., glass slide) is being acquired. In FIG. 2A, the LED-array AFP system 200 is shown at an instant when an NA-matching raw image of a sample 201 is being acquired.

The LED-array AFP system 200 includes an optical system 240 with an objective lens 244 (e.g., Plan N 20×/0.40 NA objective sold by Olympus) having an acceptance angle that accepts scattered light from the sample 201 being illuminated by the LED disk 210, a pupil 246, and a tube lens 248. The LED-array AFP system 200 also includes one or more light detector(s) 260 in the form of a camera 262 (e.g., GT6400 camera sold by Allied Vision Prosilica), the one or more light detector(s) 260 in optical communication with the tube lens 248. The one or more light detector(s) 260 are configured to acquire intensity measurements (images) based on light propagated through the optical elements in the 4-f configuration. The NA-matching LEDs 212 are configured to provide plane-wave illumination at NA-matching illumination angles that equal to, or less than the acceptance angle of the objective lens 244. The darkfield LEDs 214, 216 are configured to provide plane-wave illumination at darkfield illumination angles that are greater than the acceptance angle of the objective lens 244. The LED-array AFP system 200 includes components in a 4-f configuration (e.g., a standard 4-F microscope system) that are integrated with the multi-angle illumination from the LED disk 210. For example, the components in the 4-F configuration may include components of a IX51 inverted microscope sold by Olympus.

FIG. 3A depicts a schematic diagram of the LED disk 210 in FIGS. 2A and 2B during activation of one of the NA-matching illumination sources in the ring of NA-matching LEDs 212 providing plane-wave illumination at an NA-matching illumination angle, ONA. FIG. 3B depicts a schematic diagram of the LED disk 210 in FIGS. 2A and 2B during activation of one of the darkfield illumination sources in the first ring of darkfield LEDs 214 providing plane-wave illumination at darkfield illumination angle, ⊖_{DF}.

During each raw image acquisition, an incident planewave 211 at an illumination angle from the LED disk 210 interacts with the sample 201 such as a weakly scattering biological sample. The total optical field, containing both the unscattered and scattered light, can be captured by the light detectors 260 and only the intensities (distributions) are recorded in the image measurement. During an image acquisition procedure, the LED disk 210 provides NA-matching illumination at each of a plurality of NA-matching illumination angles sequentially (denoted by circular arrow in FIG. 2A) while the light detector(s) 260 acquires a plurality of NA-matching measurements. During the image acquisition procedure, the LED disk 210 also provides darkfield illumination at each of a plurality of darkfield angles sequentially (denoted by circular arrow in FIG. 2B) while the light detector(s) 260 acquires a plurality of darkfield measurements. The LEDs may be illuminated in any order.

LED-array AFP system 200 also include a computing device 290 in electrical communication with the one or more light detectors 260 to receive signals with intensity measurements and/or send control signals to trigger image acquisition. The computing device 290 is also in electrical communication with the LED disk 210. The computing device 290 includes a controller (e.g., microcontroller made by Arduino Uno) that sends control signals to the LED disk 210 to control illumination angles. In one implementation, the control signals may synchronize image acquisition with activation of different illumination sources. The computing device 290 may also perform other functions of the AFP system such operations of the AFP methods shown in FIGS. 14-19. Further, it should be noted that the LED-array AFP system 200 of other implementations may include additional or fewer components than those depicted in FIGS. 2A, 2B, 3A, and 3B.

FIG. 4 is a photograph of a bottom view of an LED disk 410 (e.g., an RGB LED disk) according to an embodiment. The LED disk 410 is adjustable to accommodate different acceptance angles of different objective lenses being implemented. The LED disk 410 includes eight rings of LEDs 212(1), 212(2), 212(3), 212(4), 212(5), 212(6), 212(7), and 212(8). In the illustrated example, the first ring of LEDs 212(1) is being implemented to provide illumination at illumination angles that match the acceptance angle of a specific objective lens and the other seven rings of LEDs 212(2), 212(3), 212(4), 212(5), 212(6), 212(7), and 212(8) are being implemented to provide darkfield illumination at illumination angles greater than the acceptance angle. In other implementations, a different objective lens may be used and different rings of LEDs may be implemented to provide NA-matching illumination and darkfield illumination. For instance, if the current objective lens is replaced with an objective lens having a wider acceptance angle that matches the illumination angles provided by the ring of LEDs 212(4), the ring LEDs 214(4) will be implemented to provide NA-matching illumination and one or more of the or more of the rings of LEDs 212(5), 212(6), 212(7), and 212(8) with wider diameters will be implemented to provide darkfield illumination.

FIG. 5 is a photograph of an LED-array AFP system 600 that includes a commercialized microscope body 603, according to an embodiment. The LED-array AFP system 600 includes the LED disk 410 in FIG. 4, a motorized X-Y sample stage 602 upon which a sample may be disposed during image acquisition, and a camera 660. FIG. 6 is a photograph of the LED-array AFP system 500 of FIG. 5 with the LED disk 410 installed. In this example, one of the LEDs (414) in the first ring of LEDs 212(1) is illuminated. Further, it should be noted that the LED-array AFP system 600 of other implementations may include additional or fewer components than those depicted in FIGS. 5 and 6.

### 2) Example Laser-Based AFP System

FIG. 7 depicts a schematic diagram of a laser-based analytic Fourier ptychotomography (AFP) system 700, according to an embodiment. The laser-based AFP system 700 includes an illumination system 711 having a laser source 710 such as a 532 nm continuous-wave laser (e.g., 532 nm continuous-wave laser sold by CrystaLaser Inc.), a first mirror 721, one or more multimode optical fibers 723, a fiber jitter motor 724, a second mirror 725, a first lens 726 which is a plano-convex lens, an iris 727, a galvo mirror pair 728 with 2-axis galvo mirrors (e.g., GVS 212 galvo mirror pair made by Thorlabs), a second lens 729, a third lens 730, a third mirror 732, a fourth lens 734, and a condenser 735 (e.g., U-AC condenser sold by Olympus). In one implementation, the galvo mirror pair 728 may be motorized (e.g., include a motor coupled to the two galvo mirrors). The laser beam from the laser source 710 is collimated by the first lens 726 collimated by the first lens 726, which is a plano-convex lens (e.g., plano-convex lens with f=35 mm), and raster scanned by the galvo mirror pair 728 to vary the illumination angles and corresponding incidence angles on a sample 701 being imaged. The sample 701 is disposed on a sample receptacle 702 during image acquisition. The sample receptacle may be mounted to a motorized translation stage 703 for scanning samples laterally to image across large sample areas in large FOV scanning implementations. In other implementations, the motorized translation stage 703 may be omitted.

The laser-based AFP system 700 also includes an optical system 740 including an objective lens 742 (e.g., Plan N 20×/0.40 NA objective lens sold by Olympus), a tube lens 744 (e.g., TTL180-A sold by Thorlabs), and a fourth mirror 736. The laser-based AFP system 700 also includes one or more light detectors 760 in the form of a camera 762 (e.g., PCO Edge 5.5 camera sold by Excelitas) and a computing device 790. The computing device 790 is in electronic communication with the one or more light detectors 760 to receive signals with raw intensity measurements (images) and in electronic communication with the galvo mirror pair 728 to send control signals to control illumination angles. The computing device 790 controls the illumination angles by tuning the voltages applied to galvo mirror pair 728. During image acquisition, the optical field is captured by a 4-f imaging configuration formed by the objective lens 742, the tube lens 744, and the light detector(s) 760 in the form of a camera 762.

Further, it should be noted that the AFP system 700 of other implementations may include additional or fewer components than those depicted in FIG. 7. For example, one or more of the fiber jitter motor 724, the first mirror 721, the multimode optical fiber(s) 723, the second mirror 725, the first lens 726, the iris 727, the second lens 729, the third lens 730, the third mirror 732, or the fourth lens 746 may be omitted.

The laser source 710 is optically coupled to the multimode optical fiber(s) 723. In one example, the multimode optical fiber(s) 723 includes a multimode optical fiber having a 200 μm diameter and a 0.39 NA (e.g., FT200EMT optical fiber sold by Thorlabs). In certain implementations, the multimode optical fiber(s) 723 may be mechanically jittered using the fiber jitter motor 724 in order to reduce laser speckle patterns at the camera plane. During image acquisition, the output light from the multimode optical fiber(s) 723 is collimated by the first lens 726, which is a plano-convex lens (e.g., plano-convex lens with f=35 mm), producing a plane wave directed onto the galvo mirror pair 728 used for precise control of the illumination angles. In one example, the galvo mirror pair 728 can be driven by two analog output channels (−5~+5 V) of a data acquisition card (e.g., USB-6251 sold by National Instruments). The data acquisition card may be a component of the computing device 790. In the illustrated example, the focal plane of the objective lens 742 is conjugated with a middle plane of the galvo mirror pair 728 using two 4f systems placed behind them, where the first 4f system consists of the second lens 729 (e.g., lens with f=75 mm) and the third lens 730 (e.g., lens with f=100 mm) and the second 4f system consisting of the fourth lens 746 (e.g., lens with f=100 mm) and the condenser 735. With this configuration, the incident light can be focused onto the back focal plane of the condenser 735, collimated to a plane wave before hitting the sample 701, have its incident angle controlled by the galvo mirror pair 728. The light interacting with the sample 701 is then collected by an objective lens 742 and the tube lens 744. The directions of the galvo mirror pair 728 can be programmable controlled to control the illumination angles of illumination incident to the sample. The laser-based AFP system 700 is designed to deliver the laser beam at a plurality of NA-matching illumination angles and a plurality of darkfield illumination angles to the sample 701. During image acquisition, the camera 762 records a sequence of NA-matching intensity images and a sequence of darkfield images from the designed illumination angles.

### 3) Example Rotating LED AFP System

FIG. 8 depicts a schematic diagram of a rotating LED analytic Fourier ptychotomography (AFP) system 800, according to embodiments. The rotating LED AFP system 800 includes an illumination system 810 having an LED 814 mounted to a motorized rotational stage 811 (e.g., motorized rotational stage sold by Thorlabs ELL14) to provide illumination at different illumination angles to a sample 801 being imaged. In one embodiment, the rotating LED analytic Fourier ptychotomography (AFP) system 800 implements an LED configured to provide deep ultraviolet (e.g., deep ultraviolet LED such as the 265 nm LED sold by Boston Electronics) and is referred to herein as a “DUV AFP system.”

In one implementation, the illumination system 810 may include a chip package (e.g., 265 nm UVC LED Chip-on-Board Package, 110 mW sold by Boston Electronics) with the LED 814. The chip package may be mounted on the motorized rotational stage 811 at a tilted angle using a 3D-printed connector. The sample 801 is disposed on a sample receptacle 802 during image acquisition. The sample receptacle 802 may be a quartz slide (e.g., quartz slide sold by Technical Glass Products, Inc.).

The rotating LED AFP system 800 also includes an optical system 830 including an objective lens 832 (e.g., Plan UV Infinity Corrected Objective sold by Mitutoyo), a UV-enhanced aluminum mirror 834 (e.g., PF20-03-F01 sold by Thorlabs), and a tube lens 744 (e.g., TTL200-UVB by Thorlabs). In addition, the rotating LED AFP system 800 also includes one or more light detectors 860 in the form of a camera 862, and a computing device 890 In the DUV AFP system implementation, the camera 862 is a UV-sensitive camera (e.g., Alvium 1800 U-812 UV camera sold by Allied Vision) for light detection.

The computing device 890 is in electronic communication with the camera 862 to receive signals with raw intensity measurements (images) and in electronic communication with the rotational stage 811 to send control signals to control illumination angles. During image acquisition, light transmitted through the sample 801 on the sample receptacle 802 is collected by the objective lens 832 and the tube lens 836. The optical field is captured by a 4-f imaging configuration formed by the objective lens 832, the tube lens 836, and the camera 862 and images are recorded by the camera 862. It should be noted that the rotating LED AFP system 800 of other implementations may include additional or fewer components than those depicted in FIG. 8.

### III. Analytic Fourier Ptychotomography (AFP) Methods

Analytic Fourier ptychotomography methods for volumetric refractive index imaging (generally referred to herein as “AFP methods”) can be used to analytically reconstruct complex-valued 3D-RI images (three-dimensional (3D) refractive index distributions) of, for example, biological and clinical samples. In various embodiments, the AFP method can reconstruct the complex fields from NA-matching intensity measurements using the Kramers-Kronig (K-K) relations. The AFP method analytically corrects for system aberration in the spectrum and extends the spectrum using darkfield measurements beyond the system's physical limits in 3D, leveraging the finite sample thickness (FST) prior which simplifies the inverse scattering problem by linearizing the problem. Raw image acquisition involves delivering multi-angle illumination to the sample while capturing a sequence of intensity measurements, which enables rapid imaging by eliminating the axial scanning used by conventional RI tomography. Also, AFP methods employ an analytic solution, which eliminates the need for manual parameter tuning as might be required by conventional optimization techniques. AFP methods can also increase space-bandwidth product of the AFP imaging system, which achieves a large field-of-view (FOV), provides subcellular resolution in the 3D-RI distribution, and retains a long working distance. The simplicity, robustness and efficiency of AFP techniques make them a powerful tool for quantitative volumetric RI imaging in weakly scattering samples. As such, AFP techniques have broad applicability across diverse fields, including embryo imaging, plant root and bacteria analysis, and 3D digital pathology.

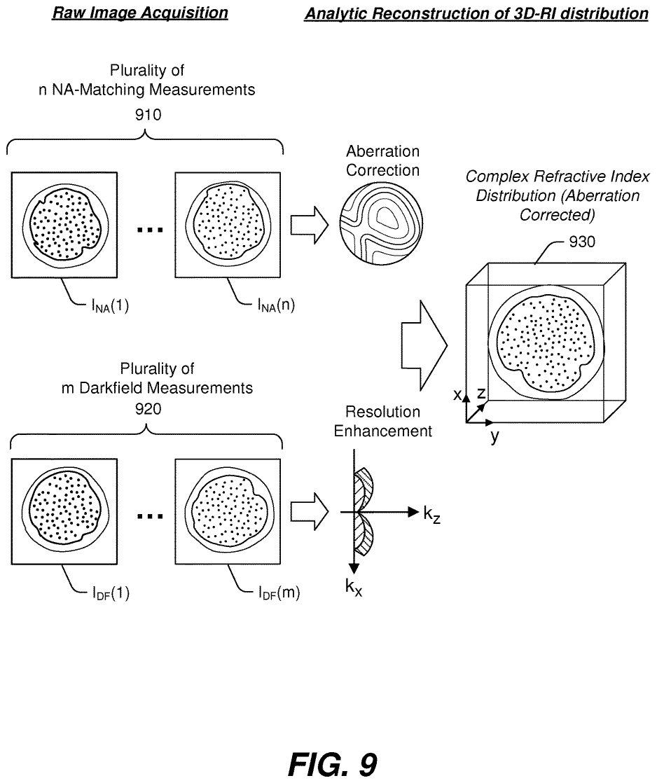

Generally speaking, AFP methods include a raw image acquisition step and an analytic reconstruction step for recovering an aberration-corrected complex-valued 3D-RI distribution (3D-RI AFP image). FIG. 9 is a schematic diagram illustrating an overview of an example of a raw image acquisition step and an analytic reconstruction step, according to embodiments. Raw image acquisition can be accomplished by employing an AFP system with multi-angle illumination (e.g., AFP system 100 in FIG. 1, AFP system 200 in FIGS. 2A and 2B, AFP system 700 in FIG. 7, AFP system 800 in FIG. 8). In some embodiments, the AFP system may include a 4-f imaging system and an illumination system configured to deliver multi-angle plane wave illumination from one or more illumination sources to the sample. The illumination system (e.g., illumination system 110 in FIG. 1, illumination system 211 in FIGS. 2A and 2B, illumination system 711 in FIG. 7, or illumination system 810 in FIG. 8) is configured to deliver NA-matching illumination at a plurality of NA-matching illumination angles and darkfield illumination at one or more darkfield illumination angles to the sample being imaged. Any suitable number of NA-matching illumination angles may be used (e.g., at least 6 NA-matching illumination angles, at least 7 NA-matching illumination angles, at least 8 NA-matching illumination angles, at least 9 NA-matching illumination angles, at least 10 NA-matching illumination angles, etc.). In some cases, a plurality of darkfield illumination angles is used. Any suitable number of darkfield illumination angles may be used (e.g., at least 1 darkfield illumination angle, at least 6 darkfield illumination angles, at least 7 darkfield illumination angles, at least 8 darkfield illumination angles, at least 9 darkfield illumination angles, at least 10 darkfield illumination angles, etc.). Light from different illumination angles interacts with the sample sequentially and gets recorded by one or more light detectors (e.g., light detector(s) 160 in FIG. 1, light detector(s) 260 in FIGS. 2A and 2B, light detector(s) 760 in FIG. 7, or light detector(s) 860 in FIG. 8). The illumination system can be implemented by various configurations of components. Some example configurations include a galvo-mirror laser scanning system, a light emitting diode (LED) array, and a single LED mounted on a rotational stage. During image acquisition, incident planewave illumination from an illumination source (e.g., one or more LEDs, laser source, etc.) are delivered to a sample at various illumination angles and the illumination interacts with the sample such as a weakly scattering sample. The total optical field, containing both the unscattered and scattered light, is captured by one or more light detectors of the AFP system and the intensity distributions are recorded in raw intensity measurements (raw images). FIG. 9 illustrates that a plurality of NA-matching intensity images (I_{NA}(1), . . . , I_{NA}(n)) 910 corresponding to a plurality of NA-matching illumination angles and a plurality of darkfield intensity images (I_{DF}(1), . . . , I_{DF} (n)) 920 corresponding to a plurality of darkfield illumination angles are captured by the AFP system. The intensity measurements may then be used for linear reconstruction to obtain an aberration-corrected, complex-valued, 3D refractive index distribution (3D-RF AFP image) 930.

In various embodiments, AFP methods recover an aberration-corrected 3D complex-valued RI distribution of a sample from a plurality of raw intensity NA-matching measurements and plurality of raw darkfield measurements in an analytic reconstruction process. Generally speaking, the analytic reconstruction process includes an NA-matching spectrum recovery procedure, an analytic aberration correction procedure, and an analytic spectrum extension procedure. To accurately retrieve sample RI distributions from intensity images, AFP methods determine the amplitude and phase of the detected optical field and correct system aberrations to restore the sample's optical field in the fully analytic reconstruction process, which ultimately recovers an aberration-corrected 3D complex-valued RI distribution. In some cases, AFP methods provide advantages such as image deblurring and resolution enhancement.

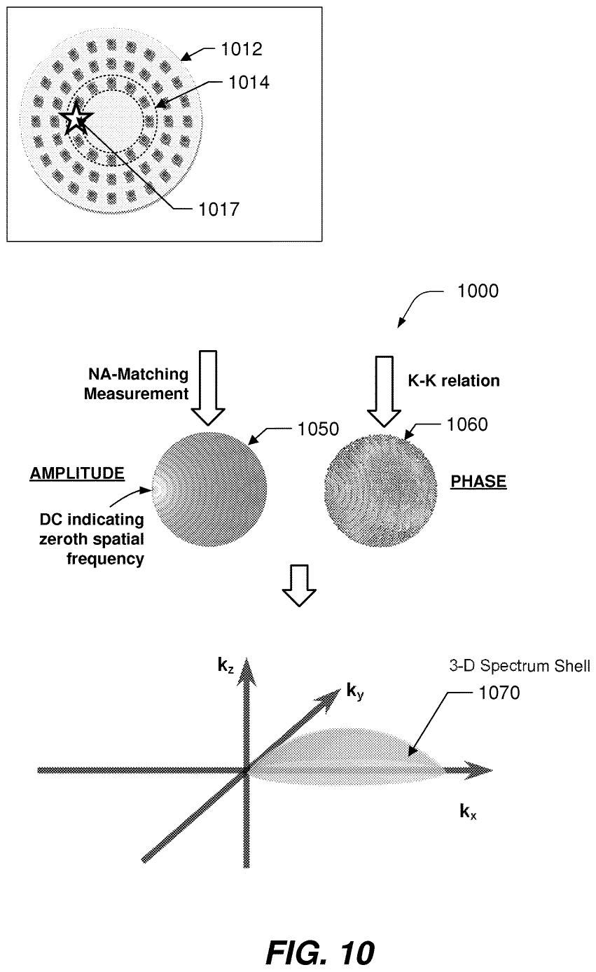

In the NA-matching spectrum recovery procedure, the AFP method analytically recovers a plurality of NA-matching sub-spectrums (spectra) from a plurality of NA-matching measurements acquired during image acquisition. FIG. 10 is a schematic diagram depicting an overview of an example of an analytic NA-matching spectrum (the Fourier transform of the total light field Eₜₒₜₐₗ) recovery procedure 1000 for recovering an NA-matching spectrum from a plurality of NA-matching measurements, according to embodiments. At the inset at the top, FIG. 10 illustrates an LED disk 1012 including a ring to NA-matching LEDs 1014 with a plurality of 12 NA-matching LEDs. In an alternative implementation, the ring to NA-matching LEDs 1014 includes 48 NA-matching LEDs.

A first NA-matching LED 1017 is shown illuminated, providing plane wave illumination at a first NA-matching illumination angle. During the raw image acquisition step, a plurality of NA-matching measurements is acquired by one or more light detectors at sample focal plane corresponding to a plurality of NA-matching illumination angles. For example, a controller may send control signals to an LED array to activate a plurality of NA-matching LEDs to provide plane wave illumination at corresponding NA-matching illumination angles at different sample times. The number of NA-matching angles have been optimized to be around 48, providing the best aberration correction performance but can be further tuned based on different needs and applications. In the NA-matching spectrum recovery procedure, for each NA-matching illumination angle, a complex-valued 2D Fourier spectrum (the Fourier transform of the total light field Eₜₒₜₐₗ) is determined from a corresponding NA-matching intensity measurement. The AFP method can analytically derive the amplitude (e.g., amplitude 1050 in FIG. 10) and phase (e.g., phase 1060 in FIG. 10) of the 2D Fourier spectrum from the intensity measurements using the Kramers-Kronig relation, under the condition of NA-matching illumination and weak scattering assumptions. The phase of each 2D Fourier spectrum (e.g., phase 1060 in FIG. 10) contains the contribution of unknown system aberration. An example of Kramers-Kronig relations can be found in Baek, Y. & Park, Y., “Intensity-based holographic imaging via space-domain Kramers-Kronig relations,” Nat. Photonics 15, 354-360 (2021), which is hereby incorporated by reference for the Kramers-Kronig relations. The complex-valued 2D Fourier spectrum generally corresponds to a small region in the spatial frequency space referred to herein as a “sub-spectrum.”

For weakly scattering samples, the first-order scattered field can be directly derived from the reconstructed sub-spectrum in 3D Fourier space. Moreover, the Fourier diffraction theorem enables the mapping of the first-order scattered field's 2D spectrum onto a 3D spectrum shell constrained by the Ewald's sphere in 3D Fourier space. The AFP method maps each of the complex-valued 2D spectrum onto a 3D spectrum shell (e.g., 3D spectrum shell 1070 in FIG. 10) constrained by the Ewald's sphere in 3D Fourier space forming a plurality of NA-matching sub-spectra. That is, the mapping procedure is repeated for each NA-matching illumination angle to reconstruct every NA-matching sub-spectrum. Since the Fourier transform of a 2D intensity image is the projection of the 3D spectrum shell 1070 onto the kₓ-k_{y} plane, the AFP method works at this kₓ-k_{y} plane to reconstruct the complex-valued 2D Fourier spectrum associated with each raw intensity NA-matching image.

FIG. 11 is a schematic diagram depicting an overview of an example of an analytic aberration correction procedure 1100 for solving for the system aberration and correcting for system aberration in each of the reconstructed NA-matching sub-spectrums recovered in the NA-matching spectrum recovery procedure. At the left inset at the top, FIG. 11 illustrates an LED disk 1112 including a ring to NA-matching LEDs 1114 with a plurality of 12 NA-matching LEDs. A first NA-matching LED 1117 is shown illuminated providing plane wave illumination at a first NA-matching illumination angle at a first sample time and a second NA-matching LED 1118 is shown illuminated at a second sample time providing plane wave illumination at a second NA-matching illumination angle. A first NA-matching measurement was acquired during plane wave illumination at the first NA-matching illumination angle and a second NA-matching measurement was acquired during plane wave illumination at the second NA-matching illumination angle. At the right at the top, FIG. 11 illustrates an example of a pair of reconstructed NA-matching sub-spectrums 1120 in 3D space (including a first NA-matching sub-spectrum 1132 recovered based on the first NA-matching measurement and a second NA-matching sub-spectrum 1134 recovered based on the second NA-matching measurement. Also illustrated are the 2D projections 1142, 1144 in the kₓ-k_{y} plane of the pair of reconstructed NA-matching sub-spectrums 1132, 1134.

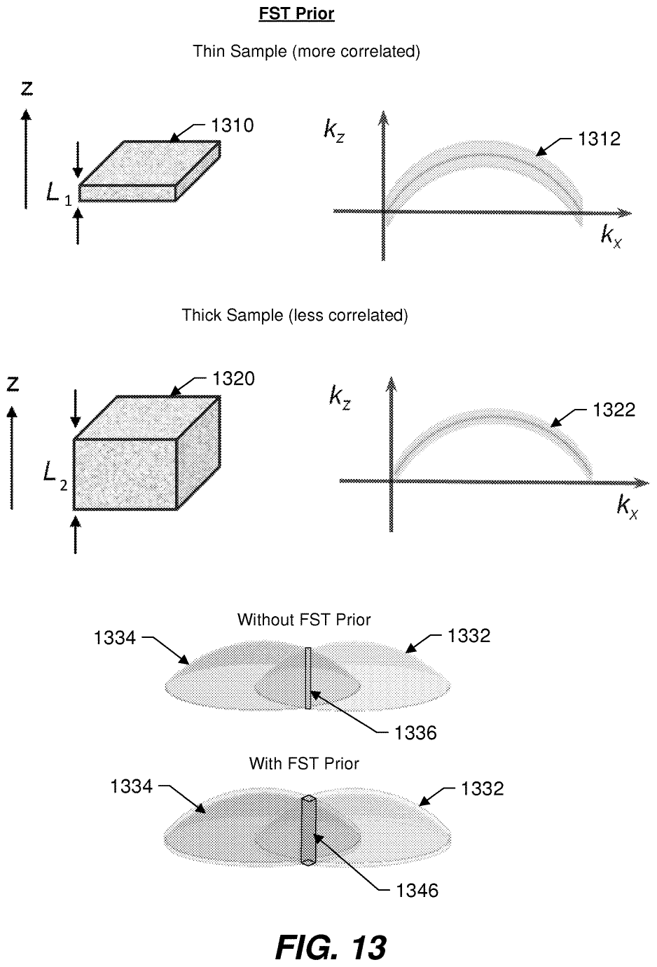

Each sub-spectrum forms a shell in 3D Fourier space. In cases where there is an overlap between two sub-spectrums based on different NA-matching illumination angles, the overlap may theoretically intersect along an arc and its 2D projection in the kₓ-k_{y} plane is a straight-line segment. FIG. 11 schematically illustrates an example of such an overlap 1136 between first and second NA-matching sub-spectrums 1132 and 1134 in the 3D spectrum domain as an arc. FIG. 11 schematically illustrates an example the overlap 1145 in the 2D projections 1142, 1444 as a straight-line segment denoted by a dashed line. This overlap region of the two sub-spectrums can be extended using the FST prior that depends on the sample thickness (e.g. sample thickness L in FIG. 13). The overlap region means that the two sub-spectrums contain the same information of the sample. For a thin sample, each sub-spectrum exhibits strong correlations between pixels along the k_{z} axis; thus, the sub-spectrum can be assumed to have a thickness greater than one pixel along the k_{z} axis with the same value (e.g. 1312 in FIG. 13). The thickness of the shell in k_{z} axis is related to the 1D Fourier transform of the sample thickness profile cut by an empirical threshold value of \sqrt{2}/2, and then the shell thickness can be used as a tolerance value. The shell thickness thus decreases as the thickness of the sample increases according to the property of Fourier transform. The FST prior region is determined by comparing the k_{z} value difference between the two overlapped sub-spectrum. Within the FST prior region, the k_{z} difference is smaller than the tolerance value (determined by sample thickness), and the Fourier spectrum of the sample can then be assumed to be the same. Due to the enlarged shell thickness, the AFP method extends the reliable overlap region between the two sub-spectra using the FST prior. In the analytic aberration correction procedure, the AFP method pairs the NA-matching sub-spectrums in groups of two, extracts the overlapping region in each pair, determines the FST prior based on the sample thickness, and extends the overlap region between each sub-spectrum pair using the FST prior. FIG. 11 illustrates an extended overlap region 1146 between the 2D projections 1142, 1444.

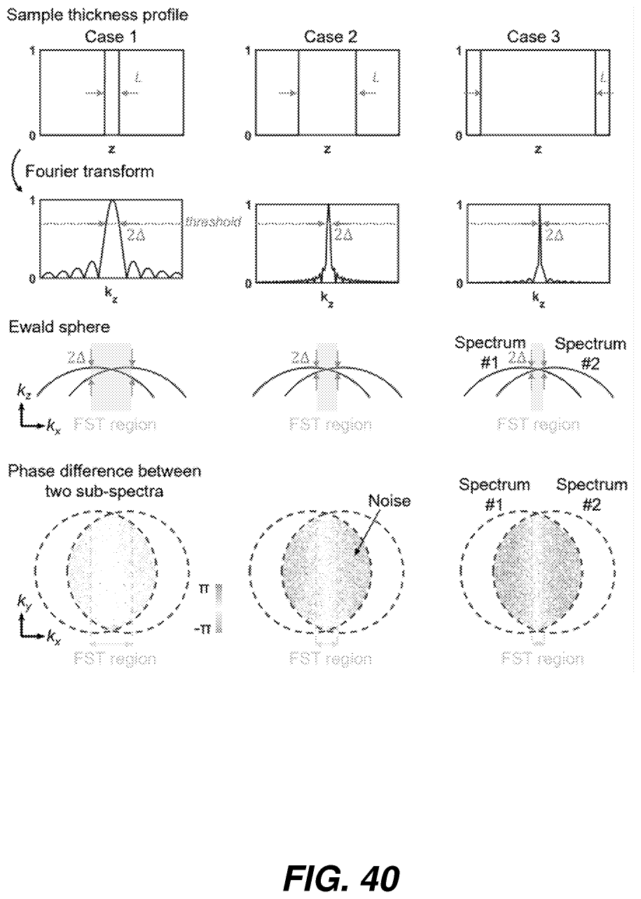

FIG. 40 depicts schematic illustrations of overlaps of 3D spectrum (FST regions) for different sample thicknesses. For a thinner sample, there is a stronger correlation in kz, which endows a lager FST region. When the sample thickness is greater, the FST region becomes smaller.

Generally speaking, the size (width) of the overlap region between two sub-spectrums (e.g., in a paired set of sub-spectrums) decreases as the sample thickness increases. FIG. 13 depicts a schematic illustration of extended overlaps with and without FST prior, according to embodiments. The amount of extension of the overlap region is related to the sample thickness. As shown, the extended overlap region 1322 between two sub-spectrums for a sample 1320 having thickness, L₂, is greater than the extended overlap region 1312 between two sub-spectrums for a sample 1310 having thickness, L₁, where L₂ is greater than L₁. Also, the overlap 1336 between sub-spectra 1332 and 1334 without FST prior is less than the extended overlap 1346 with FST prior. Within the overlap region, the sub-spectra from different illumination angles carry the same spatial frequencies of the sample. However, the phases of these sub-spectra differ due to aberrations. By subtracting the phases from these sub-spectra, the phase associated with sample spectrum cancels out, leaving only the aberration differences. These differences contribute to a linear function of the system aberration. By combining these differences in multiple NA-matching measurement pairs, a set of linear equations can be assembled that can be solved to recover an aberration function of the system aberration. The AFP method can apply the recovered aberration function to each sub-spectrum (subtract the aberration) to correct the aberration to form a plurality of aberration-corrected NA-matching sub-spectrums. The AFP method can stitch the aberration-corrected NA-matching sub-spectrums together to produce an aberration-corrected NA matching sample spectrum.

In FIG. 11, illustration 1152 depicts the aberration of the first reconstructed spectrum 1132 showing an overlap portion 1162 between the first and second reconstructed spectrums. Illustration 1154 depicts the sample's phase of first reconstructed NA-matching sub-spectrum 1132 showing an overlap portion 1164 between the first and second reconstructed spectrums. Illustration 1156 depicts the aberration of second reconstructed NA-matching sub-spectrum 1134 with an overlap portion 1166 between the first and second reconstructed spectrums. Illustration 1158 depicts the sample's phase of second NA-matching sub-spectrum 1134 showing an overlap portion 1168 between the first and second reconstructed spectrums. As shown, in the overlapping region between individual NA-matching sub-spectrums 1132 and 1134, the phase of the sample spectrum cancels out and the phase difference of the shifted CTF solely contributes to the measured phase difference. The phase difference in the overlapping portion is a linear combination of the system aberration. The phase difference is linearly dependent on the system aberration. Thus, an operator can be determined that accounts for the shift induced phase difference and this operator can be used to recover the imaging system's aberration 1170. The system aberration is subtracted from each of the reconstructed spectrum to form a plurality of aberration-corrected sub-spectrums and the aberration-corrected sub-spectrums is stitched together to produce an aberration-corrected NA matching sample spectrum 1180.

In the analytic aberration correction procedure, the AFP method applies aberration correction to each of the reconstructed sub-spectrums. The AFP method determines a finite sample thickness prior based on the thickness of the specimen being imaged. The AFP method pairs the reconstructed sub-spectrums in groups of two and the overlapping portion in each pair is extracted to solve for aberration correction. The AFP method uses the FST prior to extend the overlap region between the paired sub-spectrums and uses the positions of the overlap regions to form a position matrix (sometimes referred to herein as an “A matrix”). The AFP method subtracts the phase from each subs-spectrum pair at the overlap region to generate a plurality of phase difference vectors. The AFP method uses the position matrix and the phase difference vectors to form a set of linear equations used to solve the system aberration. The AFP method solves the system aberration using the least square solution. The AFP method subtracts the system aberration from each sub-spectrum to generate a plurality of aberration-corrected sub-spectrums. The AFP method can stitch the aberration-corrected sub-spectrums together to produce an aberration-corrected NA-matching sample spectrum.

For each darkfield illumination angle, the darkfield sub-spectrum captured consists of a known part (known component) that can be extracted from the reconstructed NA-matching sample spectrum and an unknown part (unknown component) that is new information from the darkfield measurement. Without the FST prior, the darkfield sub-spectrum associated with the darkfield measurement does not overlap with any of the reconstructed NA-matching sample spectrum. However, when applying the FST prior, the darkfield sub-spectrum can overlap with this aberration-corrected NA-matching sample spectrum. This overlapping portion of the darkfield sub-spectrum can be approximated with the reconstructed NA-matching sample spectrum according to the extended thickness of each spectrum shell determined by the FST prior. This overlapping portion can be used as the prior knowledge (known component) in the subsequent reconstruction. The rest of the spectrum can be treated as an unknown component to be solved. The cross-correlation of the prior sub-spectrum and the unknown component corresponds to a linear region in the Fourier transform of a darkfield measurement. This cross-correlation endows a set of linear equations with respect to the unknown part. The unknown component can be solved in an analytic least-squares fashion. The darkfield-extended spectrum can then be reconstructed by synthesizing all darkfield sub-spectra with the NA-matching spectrum ptychographically. Finally, the complex-valued volumetric RI distribution can be obtained by applying a linear transform to the 3D synthetic spectrum.

In the analytic spectrum extension procedure, the AFP method analytically extends darkfield spectrum of the sample spectrum using the darkfield measurements under the FST prior. The AFP method sequentially reconstructs for each of the darkfield illumination angles, a corrected darkfield sub-spectrum that is treated as prior knowledge (known component). For each darkfield illumination angle, a known component of the reconstructed NA-matching sample spectrum is extracted. The AFP method constructs a cross-correlation operator based on the known components and the cross-correlation operator is used to form a set of linear equations. The AFP method solves the linear equations using the least-squares relation for the unknown components of the sample spectrum. The AFP method ptychographically synthesizes the darkfield sub-spectrums with the NA-matching Sub-spectrums to generate a darkfield-extended sample spectrum.

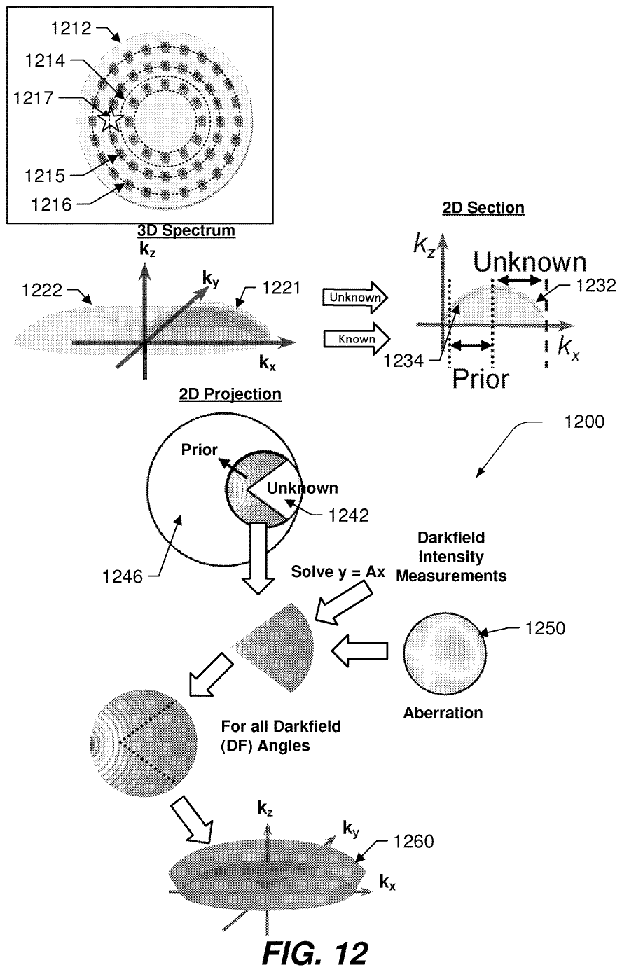

FIG. 12 is a schematic diagram depicting an overview of an example of an analytic darkfield spectrum extension procedure 1200, according to an embodiment. At the left inset at the top, FIG. 12 illustrates an LED disk 1212 including a ring of NA-matching LEDs 1214, a first ring of darkfield LEDs 1215, and a second ring of darkfield LEDs 1216. A first darkfield LED 1217 in the first ring of darkfield LEDs 1215 is shown illuminated providing plane wave illumination at a first darkfield illumination angle at a first sample time. A first darkfield measurement was acquired during plane wave illumination at the first darkfield illumination angle. Below the inset, FIG. 12 illustrates an example of the darkfield spectrum from the first darkfield measurement 1121 and its 3D relation with the aberration-corrected complex-valued NA matching spectrum 1122 obtained from the analytic aberration correction procedure, and a 2D section of the known portion 1234 and a 2D section of the unknown portion 1232. As shown, a known portion 1234 of the sample spectrum can be extracted from the NA-matching spectrum 1246 and an unknown component 1242 can be linearly solved (y=Ax) using the darkfield intensity measurements and the reconstructed aberration 1250. As illustrated, darkfield sub-spectrums are ptychographically synthesized with the NA-matching Sub-spectrums to generate a darkfield-extended sample spectrum 1260.

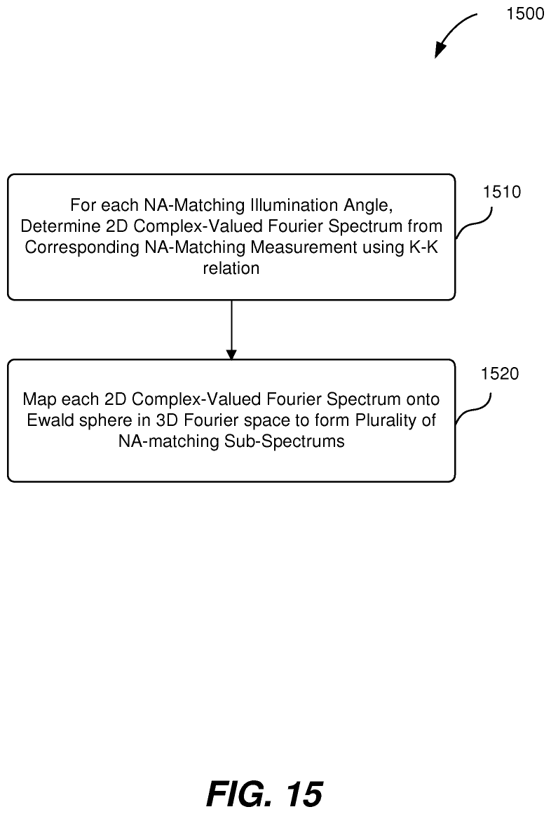

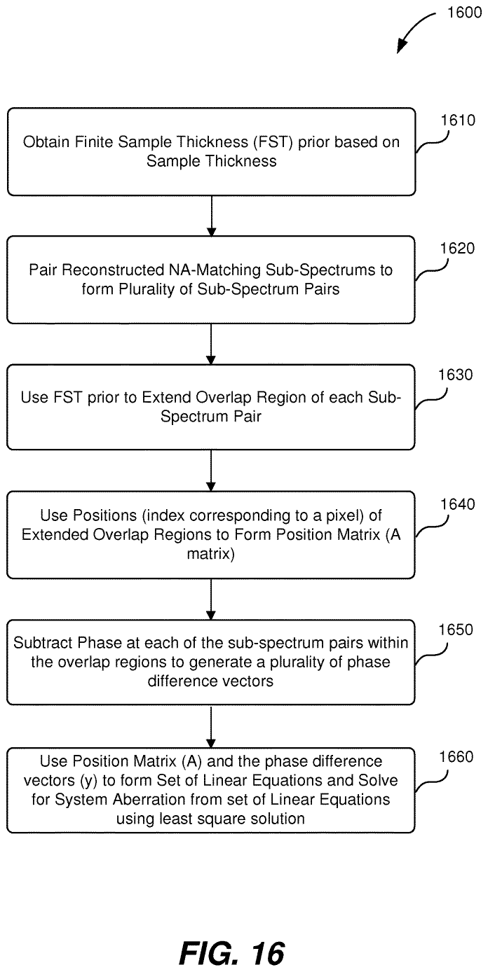

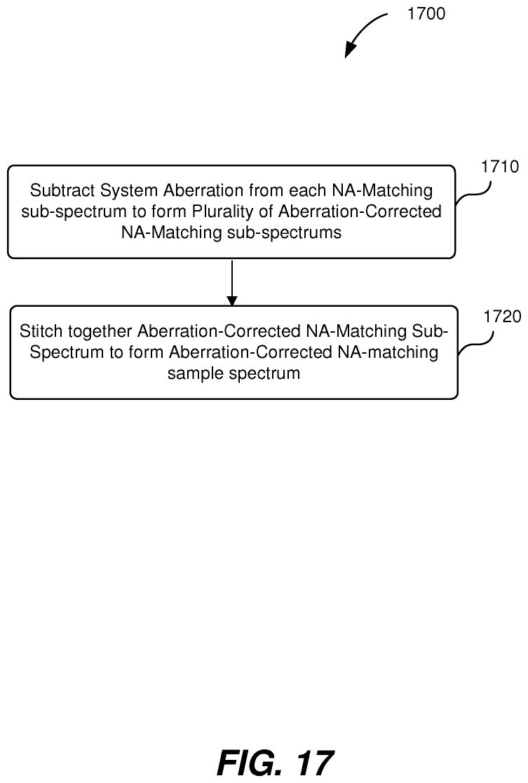

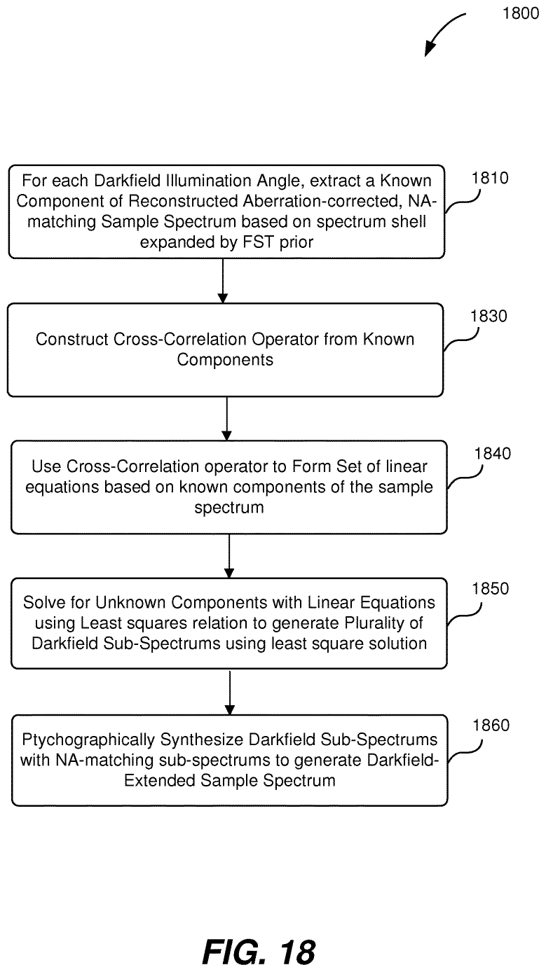

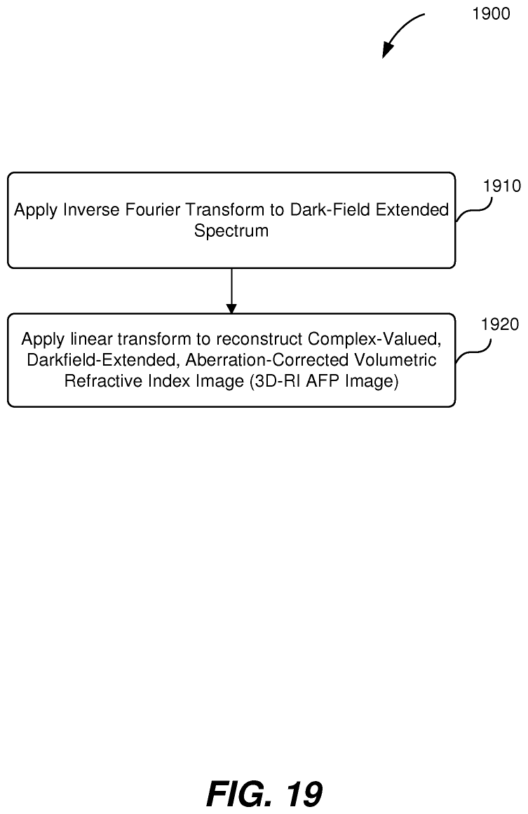

FIG. 14 depicts a flow diagram 1400 of an example of operations of an AFP imaging method, according to various embodiments. FIG. 15 depicts a flow diagram 1500 of an example of suboperations of block 1420 in FIG. 14, according to an embodiment. FIG. 16 depicts a flow diagram 1500 of an example of suboperations of block 1430 in FIG. 14, according to an embodiment. FIG. 17 is a depicts a flow diagram 1500 of suboperations of block 1440 in FIG. 14, according to an embodiment. FIG. 18 depicts a flow diagram 1500 of an example of suboperations of block 1450 in FIG. 14, according to an embodiment. FIG. 19 depicts a flow diagram 1500 of an example of suboperations of block 1460 in FIG. 14, according to an embodiment. One or more of the functions of the operations or suboperations of the AFP imaging method may be performed by a computing device (e.g., computing device 190 in FIG. 1, computing device 290 of FIGS. 2A and 2B, computing device 790 in FIG. 1, computing device 790 in FIG. 7, computing device 890 in FIG. 8 and computing device(s) 3990 in FIG. 39. Means for performing the functionality illustrated in one or more of the operations shown in these figures may include hardware and/or software components of a computing device, such as, for example, a controller apparatus, or a computer-readable apparatus including a storage medium storing computer-readable and/or computer-executable instructions that are configured to, when executed by at least one processor, cause the at least one processor or another apparatus to perform the functions. It should also be noted that the operations or suboperations may be performed in any suitable order, not necessarily the order depicted in FIGS. 14-19.

FIG. 14 depicts a flow diagram 1400 of an example of an AFP imaging method, according to various embodiments. At block 1410, a plurality of NA-matching intensity measurements and a plurality of darkfield measurements of a sample are obtained. The NA-matching intensity measurements and darkfield measurements may be retrieved from memory or may be communicated in signals from one or more light detectors (e.g., light detector(s) 160 in FIG. 1, light detector(s) 260 in FIGS. 2A and 2B, light detector(s) 760 in FIG. 7, or light detector(s) 860 in FIG. 8) of an AFP system (e.g., AFP system 100 in FIG. 1, AFP system 200 in FIGS. 2A and 2B, AFP system 700 in FIG. 7, or AFP system 800 in FIG. 8) during a raw image acquisition step.

For example, during a raw image acquisition step of an implementation, the NA-matching intensity measurements are acquired sequentially by light detector(s) while the illumination system (e.g., illumination system 110 in FIG. 1, illumination system 711 in FIG. 7, or illumination system 810 in FIG. 8) varies NA-matching illumination angles that are equal to, or nearly equal to a maximum acceptance angle of the collection optics (e.g., collection optics 142 in FIG. 1) of the AFP system. For example, the NA-matching illumination angles may be less than 1% of the acceptance angle, less than 2% of the acceptance angle, less than 5% of the acceptance angle, etc. During the raw acquisition step, the darkfield intensity measurements are also acquired sequentially by the light detector(s) while the illumination system varies darkfield illumination angles that are greater than the maximum acceptance angle of the collection optics of the AFP system. In one example, the darkfield illumination angles may be in a range of 1 degree to 5 degrees greater than the maximum acceptance angle. In another example, the darkfield illumination angles may be in a range of 3 degrees to 5 degrees greater than the maximum acceptance angle. In another example, the darkfield illumination angles may be in a range of 1 degree to 5 degrees greater than the maximum acceptance angle. In another example, the darkfield illumination angles may be more than 1 degree greater than the maximum acceptance angle. In some embodiments, each NA-matching intensity measurement may be acquired during an exposure duration during which the sample is illuminated by plane-wave illumination from an illumination source at one of the NA-matching illumination angles and each darkfield intensity measurement may be acquired during an exposure duration during which the sample is illuminated by plane-wave illumination from an illumination source at one of the darkfield illumination angles. In other embodiments, multiplexed illumination may be employed where the specimen is illuminated by a sequence of illumination patterns where each illumination pattern includes simultaneous illumination from multiple illumination angles. In some embodiments, a computing device (e.g., computing device 190 in FIG. 1, computing device 290 in FIGS. 2A and 2B, computing device 790 in FIG. 7, or computing device 890 in FIG. 8) may send control signals to the illumination system to control the illumination angles. In addition or alternatively, the computing device may send control signals to the light detectors to cause image acquisition. In some cases, the computing device may be a controller or include a controller for sending control signals.

The AFP imaging method then determines an aberration-corrected NA-matching 3D sample spectrum based at least in part on the NA-matching intensity measurements and an FST prior. Some details of this operation are described with reference to blocks 1420, 1430, and 1440. At block 1420, the AFP imaging method analytically recovers a plurality of NA-matching sub-spectrums (NA-matching spectra) from the plurality of NA-matching intensity measurements using Kramers-Kronig (K-K) relation. An example of K-K relation can be found in Baek, Y. & Park, Y., “Intensity-based holographic imaging via space-domain Kramers-Kronig relations,” Nat. Photonics 15, 354-360 (2021), which is hereby incorporated by reference for the Kramers-Kronig relations.

FIG. 15 is a flow diagram 1500 depicting an example of suboperations of block 1420 in FIG. 14. At block 1510, the AFP imaging method determines, for each NA-matching illumination angle of the plurality of NA-matching illumination angles, a complex-valued 2D Fourier spectrum from an NA-matching intensity measurement acquired during illumination at the corresponding NA-matching illumination angle. The AFP imaging method can analytically derive the amplitude and phase of the 2D Fourier spectrum from the NA-matching intensity measurement using the Kramers-Kronig relation. At block 1510, the AFP imaging method determines a plurality of complex-valued 2D Fourier spectrums corresponding to respective NA-matching illumination angles. Each complex-valued 2D Fourier spectrum corresponds to a small region (sub-spectrum) in the spatial frequency space.

The Fourier diffraction theorem enables mapping the 2D spectrum of the complex light field onto a 3D spectrum shell constrained by the Ewald's sphere in 3D Fourier space. At block 1520, the AFP imaging method maps each of the complex-valued 2D Fourier spectrums onto a 3D spectrum shell constrained by an Ewald's sphere in 3D Fourier space to form a plurality of NA-matching sub-spectrums.

Returning to FIG. 14, at block 1430, the AFP imaging method solves for system aberration using the FST prior. FIG. 16 is a flow diagram 1600 depicting an example of suboperations of block 1430 in FIG. 14. At block 1610, the AFP imaging method obtains a finite sample thickness (FST) prior based on the thickness of the sample being imaged. The thickness of the sample can be estimated based on prior knowledge of the sample type and by imaging it under a bright-field microscope. The FST prior improves the aberration correction accuracy and the feasibility of analytic darkfield reconstruction by extending the Fourier spectrum shell thickness based on different spectrum correlations.

At block 1620, the AFP imaging method pairs NA-matching sub-spectrums to form a plurality of NA-matching sub-spectrum pairs. FIG. 11 illustrates an example of a pair of NA-matching sub-spectrums 1120 including a first NA-matching spectrum 1132 and a second NA-matching spectrum 1134. In the 3D domain. FIG. 11 also illustrates the 2D projections 1142, 1144.

In cases where there is an overlap between two sub-spectrums, the overlap may theoretically intersect along an arc and its 2D projection in the kₓ-k_{y} plane is a straight-line segment. FIG. 11 illustrates an example of an overlap between the first NA-matching sub-spectrum 1132 and a second NA-matching sub-spectrum 1134 as an arc in the 3D domain and its 2D projection in the kₓ-k_{y} plane as a straight-line segment. The AFP imaging method determines the FST prior based on the sample thickness and extends the overlap region between each sub-spectrum pair using the FST prior. At block 1630, the AFP imaging method uses the FST prior to extend the overlap region of each sub-spectrum pair. FIG. 11 illustrates an extended overlap region 1146 that has been extended by an FST prior.

At block 1640, the AFP imaging method uses the positions of the overlap regions to generate a position matrix (A matrix). Each row of this position matrix represents information extracted from one pixel of the overlap FST region and consists of a pair of ‘+1’ and ‘−1’ values corresponding to the position of this pixel relative to the two sub-spectra. This matrix gives the encoding position information about which two pixels are subtracted, especially related to the unknown aberration, since the sample-related phase cancels out in the overlap FST region in spectrum domain.

At block 1650, the AFP imaging method subtracts the phase of each of the sub-spectrum pairs to generate a plurality of phase difference vectors. As shown in FIG. 11, the phase difference vector comprises phase difference values from all pixels within the overlap FST region, obtained by subtracting the phase of each pair of 2D spectra and stacking the results vertically into a single column. This vector forms ‘y’ in the linear equation ‘y=Ax’, where A is the position matrix and x is the unknown aberration.

At block 1660, the AFP imaging method uses the position matrix and the phase difference vectors to form a set of linear equations used to solve for system aberration. This set of linear equations is formed by ‘y’ representing the phase difference vector, A representing the position matrix and x is the unknown aberration to be solved. The AFP method then solves for system aberration using the set of linear equations using the least squares solution. This process is analytic without parameter tuning.

Returning to FIG. 14, at block 1440, the AFP imaging method removes the system aberration from the sub-spectrums to form an aberration-corrected NA-matching sample spectrum. FIG. 17 is a flow diagram 1700 depicting an example of suboperations of block 1440 in FIG. 14. At block 1710, the AFP imaging method subtracts the system aberration from each of the sub-spectrums to form a plurality of aberration-corrected sub-spectrums. At block 1720, the AFP imaging method stitches the aberration-corrected sub-spectrums together to form an aberration-corrected NA-matching sample spectrum. The 3D ptychographic stitching process is based on the Fourier diffraction theorem, where the stitching position of each sub-spectrum is determined by its relative shift with respect to the central spectrum coordinates, as defined by the illumination angles. The sub-spectra are added according to these relative shifts, and the result is normalized by a weight matrix that accounts for the number of times each pixel is sampled.

Returning to FIG. 14, at block 1450, the AFP imaging method extends the aberration-corrected NA-matching 3D sample spectrum using plurality of darkfield measurements. FIG. 18 is a flow diagram 1800 depicting an example of suboperations of block 1450 in FIG. 14.

The AFP imaging method sequentially extracts for each of the darkfield illumination angles, a portion of darkfield sub-spectrum that is treated as prior knowledge (known component). At block 1810, for each darkfield illumination angle, the AFP imaging method extracts a known component of the reconstructed NA-matching, aberration-corrected sample spectrum based on the thickness of the spectrum shell expanded by the FST prior. Based on the formation of the FST prior, correlations in the sample spectrum along the k_{z} axis can be leveraged to serve as known components of the dark-field spectrum, directly obtained from a portion of the known NA-matching 3D spectrum. That is to say, the known component may be cropped out from the reconstructed NA-matching, aberration-corrected sample spectrum based on the portion of the sample spectrum associated with the darkfield measurement.

At block 1830, the AFP imaging method constructs a correlation operator from known components of the sample spectrum based in part on the extracted known components. In the Fourier spectrum of each darkfield intensity measurement, there exists a region containing the linear cross-correlation relation between the known and unknown part of the darkfield spectrum. To obtain a clean linear relation, the autocorrelation term of the known spectrum needs to be first subtracted from the intensity spectrum, and the linear region needs to be computed based on geometry shape of the known and unknown region. The correlation operator may be used to generate a set of linear equations that can be used to solve for the unknown components of the sample spectrum. The correlation operator may be used to form a closed form solution used to determine the unknown part of the sample spectrum.

At block 1840, the AFP imaging method uses the correlation operator to form a set of linear equations based on the known components extracted from the sample spectrum.

At block 1850, the AFP imaging method solves for the unknown components based on the set of linear equations using the least squares solution and combines with the known components to generate a plurality of darkfield subs-spectrums.

At block 1860, the AFP imaging method ptychographically synthesizes the darkfield sub-spectrums with NA-matching sub-spectrums to generate a darkfield-extended sample spectrum. For example, for each darkfield illumination angle, the corresponding darkfield sub-spectrum may be stitched with the known component of the reconstructed NA-matching, aberration-corrected sample spectrum with stitching position determined by the darkfield illumination angle. This finally forms the aberration-free dark-field extended sample spectrum.

Returning to FIG. 14, at block 1460, the AFP imaging method reconstructs a volumetric refractive index distribution of the sample from the dark-field extended sample spectrum. FIG. 19 is a flow diagram 1900 depicting an example of suboperations of block 1450 in FIG. 14. At block 1910, the AFP imaging method applies 3D inverse Fourier transform to darkfield-extended sample spectrum and obtain the complex light field of the sample. At block 1920, the AFP imaging method applies a linear transform among complex light field, scattering potential and refractive index to form to the transformed sample spectrum to reconstruct a complex-valued, darkfield-extended, aberration corrected volumetric refractive index image (3D-RI AFP image).

### Finite Sample Thickness (FST) Prior

For a general scattering sample, the scattered light field arising from the incident field interacting with superficial layers of the sample will become progressively more disordered as it interacts with ever more scatterers during its travel through the sample. When the scattered field eventually becomes comparable to the unaltered incident field, the multi-scattered light field is no longer negligible. Thus, for a thick sample such as thick tissues, the output field depends nonlinearly on the sample's complex refractive index (RI).

For samples that are sufficiently thin and sparse, the forward scattering dominates, and the interactions between the scattered field and sample at a deeper layer can be ignored. Using this, the output light field after passing through an extended sample can be approximated by a linear light-matter interaction model where only the first-order scattered light is taken into consideration and the multi-scattered light field is ignored. In some embodiments, AFP imaging methods consider only the first-order scattered light and implement a finite sample thickness (FST) prior to linearize reconstruction of the RF 3D map (image).

The total light field at a location x is given by:

$$U ( x ) = {U}_{in} ( x ) + {U}_{s} ( x ) \qquad ( Eqn . 1 )$$

where Uin(x) is the scattered field and Us(x) is the incident field.

In various embodiments, AFP imaging methods use a first order approximation of U(x). These first-order approximations mean that multiple scattering can be ignored and only first order scattering considered. In some cases, AFP imaging methods use the first order Rytov approximation of U(x) given by:

$$U ( x ) \approx {e}^{{Φ}_{0} ( x ) + {Φ}_{1} ( x )} = {U}_{in} ( x ) exp [ \frac{1}{{U}_{i n} ( x )} \int G ( x - {x}^{′} ) V ( {x}^{′} ) {U}_{i n} ( {x}^{′} ) {dx}^{′} ] \qquad ( Eqn . 2 )$$

By using a first-order approximation of U(x), a generalized coherent transfer function (CTF) in 3D which forms a cap of an Ewald sphere with a radius defined by the wavenumber

$${k}_{0} := ( \frac{2 π {n}_{m}}{λ} ) ,$$

which is given by:

$$H ( k ) := 𝕝 ( {k}_{x}^{2} + {k}_{y}^{2} + {k}_{N A}^{2} ) \cdot 𝕝 ( {k}_{Z} > 0 ) {e}^{j ϕ ( k )} s . t . \vert k \vert = {k}_{0} \qquad ( Eqn . 3 )$$

where ∥(⋅) is the indicator function

$$, k = {[ {k}_{x} , {k}_{y} , {k}_{z} ]}^{T}$$

denotes the spatial frequency and

$${k}_{N A} = \frac{2 π}{λ} NA$$

is the maximum spatial frequency that can be captured by the imaging system, and φ(k) denotes the system aberration.

An imaging system only captures a small upper cap of the Ewald sphere. By using only the overlap, linear equations can be constructed that can be solved for both correcting aberration and extending the sample spectrum. However, for a general extended sample, the area of such spectrum overlap is limited which makes the linear equation set underdetermined. The FST prior can be introduced to bridge the gap and lead to an analytically 3D RI reconstruction from measurements under a sequence of angled illuminations.

Assuming Y(z)∈L₂( [symbol] ) is a function whose energy is finite, then the Fourier transform of Y(z) is defined as:

$$\hat{Y} ( k ) = \int Y ( z ) {e}^{- j 2 π kz} dz \qquad ( Eqn . 4 )$$

where Rect(⋅) is the is the rectangle function and L is the thickness (and is small). The Fourier transform of Y′(z) is given by:

$${\hat{Y}}^{′} ( k ) = [ \hat{Y} ( {k}^{′} ) * Lsinc ( {k}^{′} L ) ] ( k ) = \int \hat{Y} ( k - {k}^{′} ) \cdot Lsinc ( {k}^{′} L ) {dk}^{′} \qquad ( Eqn . 5 )$$

where sinc(⋅) is the sinc function.
when Ŷ′ is evaluated at k+Δk, the following is provided:

$$\hat{Y} ( k + Δ k ) = [ \hat{Y} ( {k}^{′} ) * Lsinc ( {k}^{′} L ) ] ( k + Δ k ) = \int [ \hat{Y} ( k + Δ k ) - {k}^{′} ] \cdot Lsinc ( {k}^{′} L ) {dk}^{′} = \int \hat{Y} ( k - {k}^{″} ) \cdot Lsinc [ {k}^{″} + Δ k ) L ] {dk}^{″} = \int \hat{Y} ( k - {k}^{′} ) \cdot Lsinc [ ( {k}^{′} + Δ k ) L ] {dk}^{′} \qquad ( Eqn . 6 )$$

The FST prior introduces a correlation between the sampled axial spatial frequency k and its neighboring spatial frequency k+Δk. Note that in the last row, the sinc function and the Fourier transform of the original signal are multiplied together and then integrated. Because the window function is assumed to be narrow, the sinc function is “thick: in the spatial frequency domain and a small shift does not significantly change its value. As illustrated, these signals two are now correlated. This is the key idea of the FST prior: it induces a correlation between the sampled axial spatial frequency and its neighboring spatial frequencies. When the rectangle function is narrow, its Fourier transform gets smoother in the spatial frequency domain, and a small coordinate shift does not drastically change its value. This means that a certain spatial frequency can be well approximated by its neighbors. Thus, by incorporating the FST prior, the “cap” sampled by the 3D CTF now obtains a certain thickness associated with the size of the rectangle. This additional thickness can be used to construct solvable linear equations with respect to both system's aberration and the sample's spectrum using a reasonable number of measurements. This is because the FST prior can be used to increase the overlap area of the sampled spectra pairs without additional measurements.

The FST prior induces a correlation between the sampled axial spatial frequency k_{z} and its neighboring spatial frequencies (e.g., k_{z}+Δk_{z}). AFP imaging methods use the overlap between pairs of reconstructed spectra (sub-spectrums) and the FST prior to construct linear equations that can be solved for both correcting system aberration and extending sample spectrum.

### Aberration Correction

In various embodiments, AFP imaging methods use the complex sub-spectrum (spectra) reconstructed for each of the NA-matching measurements to solve for the aberration correction. The phase difference in the overlapping region between two sub-spectrums (spectra) associated with NA-matching measurements can be used to solve for a linear equation with respect the system's aberration used to correct the reconstructed sample spectrum. For a general sample where the thickness is not constrained, the overlap region is limited. In some embodiments, the AFP imaging methods introduce the FST prior to increase the overlap region and make the linear equation more easily solvable.

With Zernike decomposition, the aberration of the imaging system is given by:

$$φ = Zc \qquad ( Eqn . 7 )$$

where c∈ [symbol] ^{z+1} is the corresponding Zernike coefficient and each column of Z represents a particular Zernike mode. The 2D aberration Φ of the imaging system is given by:

$$Φ = {Flat}_{N , N}^{- 1} ( φ ) = {Flat}_{N , N}^{- 1} ( Zc ) \qquad ( Eqn . 8 )$$

In some cases, the following weighted equation may be used to solve for the system aberration to emphasis certain spatial frequencies in the spectrum that are stronger than other frequencies:

$$( W [ DZ {F}^{0} ] ) [ \begin{matrix}c \\ ϕ\end{matrix} ] = W β Δ \qquad ( Eqn . 9 )$$

### Darkfield Extension

The scattering potential, V, is defined as:

$$V ( x ) : = {( \frac{2 π}{λ} )}^{2} [ {n ( x )}^{2} - {n}_{m}^{2} ] \qquad ( Eqn . 10 )$$

where n(x) is the refractive index of the sample at a location x∈R3 in 3D space, nm is the refractive index of the surrounding medium, and λ is the wavelength of the incident light in free space.

The scattering potential, V, can be solved with a Wiener filter as follows:

$$V = \frac{1}{{U}_{i n}} {F}^{- 1} \{ \frac{\text{?} ( \hat{U} - {\hat{U}}_{i n} )}{{\vert \hat{G} \vert}^{2} + ε} \} \qquad ( Eqn . 11 )$$

where ε is a small constant to avoid division by zero and G* is its complex conjugate. The 3D refractive index distribution can be obtained via the definition of the scattering potential at Eqn. 10.

### IV. Experimental Results

The AFP system 200 shown in, and described with respect to, FIGS. 2A and 2B and the AFP imaging method described with respect to FIG. 14 were used to reconstruct 3D-RI AFP images of polystyrene beads under various kinds of aberration conditions. The laser-based AFP system 700 shown in, and described with respect to, FIG. 7 and the AFP imaging method described with respect to FIG. 14 were used to reconstruct 3D-RI AFP images of mouse embryos and an algae sample. The DUV AFP system 800 shown in, and described with respect to, FIG. 8 and the AFP imaging method described with respect to FIG. 14 were used to reconstruct 3D-RI AFP images of human gastric adenocarcinoma cancer cells. Generally speaking, these experimental results demonstrate that AFP techniques may enhance image quality and resolution under various aberration conditions. These experimental results demonstrated that AFP techniques have broad applicability across diverse fields, including embryo imaging, plant root and bacteria analysis, and 3D digital pathology.

The experimental results include AFP corrected aberrations associated with 25 Zernike modes (with maximal phase difference of 2.3π and maximal Zernike coefficient value of 4) that provided a two-fold resolution enhancement in all directions. The simplicity and robustness of AFP techniques may make it an advantageous imaging technology for quantitative 3D analysis in biological, microbial ecological, and medical studies.

AFP Imaging with 6 μm Polystyrene Beads

AFP techniques were to reconstruct the 3D-RI profile and correct system aberration using 6-μm polystyrene beads in both simulations and experiments. In the simulation, a 6-μm diameter bead (n=1.59) was immersed in a refractive index liquid (n=1.58), with a known aberration function consisting of six dominant Zernike modes applied to the pupil plane.

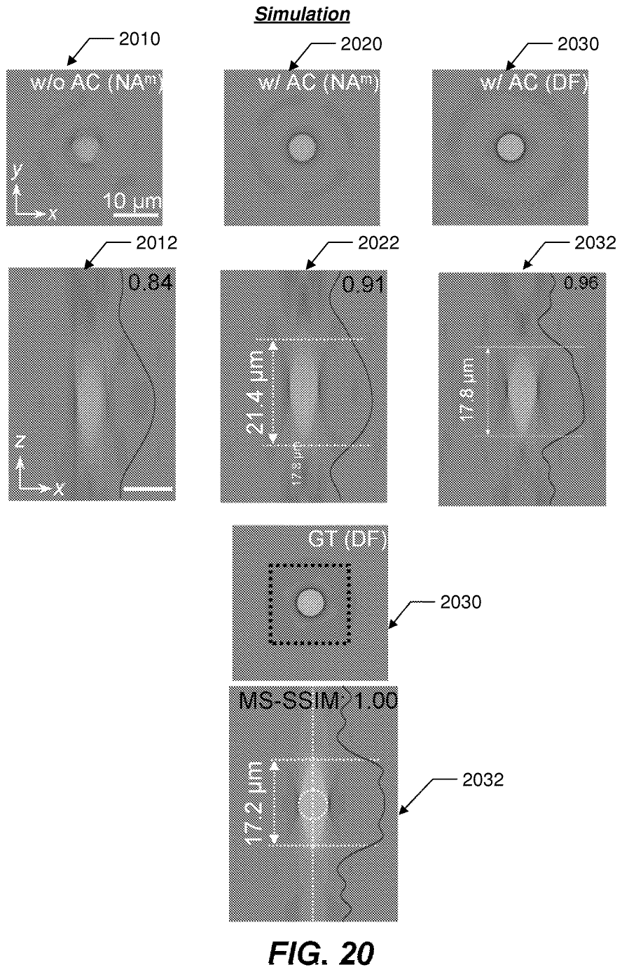

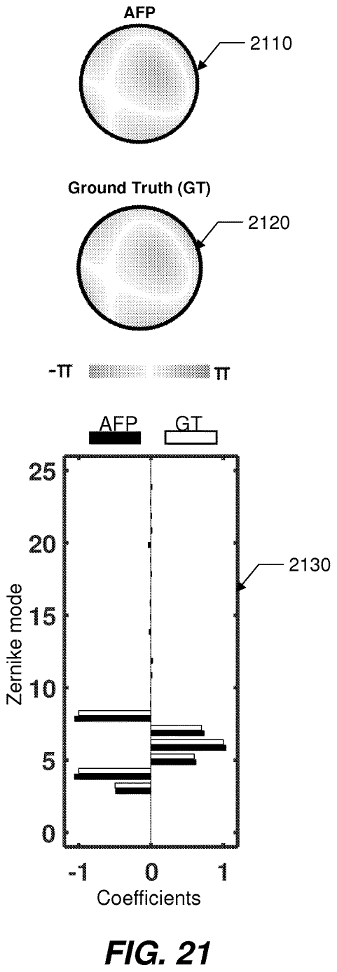

FIG. 20 includes simulated 3D-RI AFP images 2010, 2012 of a 6-μm polystyrene bead in the x-y view and x-z view without aberration correction, simulated 3D-RI AFP images 2020, 2022 of the 6-μm polystyrene bead in the x-y view and x-z view with aberration correction, simulated 3D-RI AFP images 2030, 2032 of the 6-μm polystyrene bead in the x-y view and x-z view with darkfield extension, and ground truth ground truth image of the 6-μm polystyrene bead. FIG. 21 includes illustrations of the pupil function 2110, 2120 and illustration of its Zernike decompositions 2130 from AFP reconstruction and ground truth images. FIG. 21 provides a comparison between aberrations reconstructed by AFP and ground truth images, obtained while imaging a 6-μm polystyrene bead. As shown in images 2010, 2012 in FIG. 20, without aberration correction, the 3D reconstruction showed severe distortions. As shown in illustrations 2020, 2022 in FIG. 20, by applying aberration correction with AFP imaging method, the bead's symmetry and uniformity was restored. As shown in images 2030, 2032 in FIG. 20, darkfield extension further improved axial resolution by another twofold compared to NA-matching-only illumination. The x-y and x-z sectional profiles demonstrated a high reconstruction quality and were matched with the ground truth images 2030, 2032 in FIG. 20 obtained with the same 3D spatial frequency support. Additionally, the Zernike coefficients 2130 in FIG. 21 of the recovered aberration match the known aberration of the ground truth image 2030, verifying the accuracy of the aberration correction applied by the AFP imaging method.

In the experiment, a bead sample was imaged using parameters that were matched to those in the simulation. To experimentally evaluate AFP's performance under different aberration conditions, three distinct aberrations were applied: defocus-dominant aberration through sample defocusing, spherical-dominant aberration by inverting slide placement, and random aberrations by attaching scotch tape near the pupil plane of the objective lens. Forty-eight (48) NA-matching (illumination NA=0.40) and one hundred forty four (144) darkfield images (illumination NA≈0.46, 0.51, 0.58 on three rings) were acquired using an LED array-based setup of the AFP system 200 shown in, and described with respect to, FIGS. 2A and 2B with sequential angular illuminations. This configuration extended the synthetic NA from 0.40 (coherent imaging) to 0.80 (NA-matching) and 0.98 (darkfield), resulting in more than a twofold enhancement in lateral resolution.

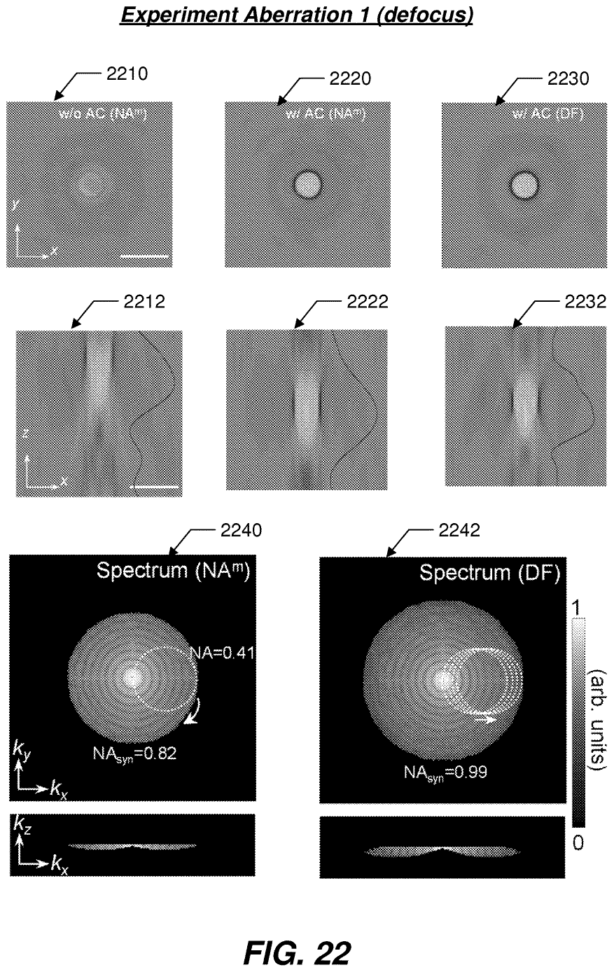

FIG. 22 includes experimentally-derived (defocus) 3D-RI AFP images 2210, 2212 of a 6-μm polystyrene bead in the x-y view and x-z view without aberration correction, experimentally-derived 3D-RI AFP images 2220, 2222 of the 6-μm polystyrene bead in the x-y view and x-z view with aberration correction, experimentally-derived 3D-RI AFP images 2230, 2232 of the 6-μm polystyrene bead in the x-y view and x-z view with darkfield extension, and a visualization of darkfield-extended log-scaled spectrum amplitude 2242 log-scaled spectrum amplitude where the ring-shaped spectrum structures are clearly visible. In this experiment, the system aberration was defocus.

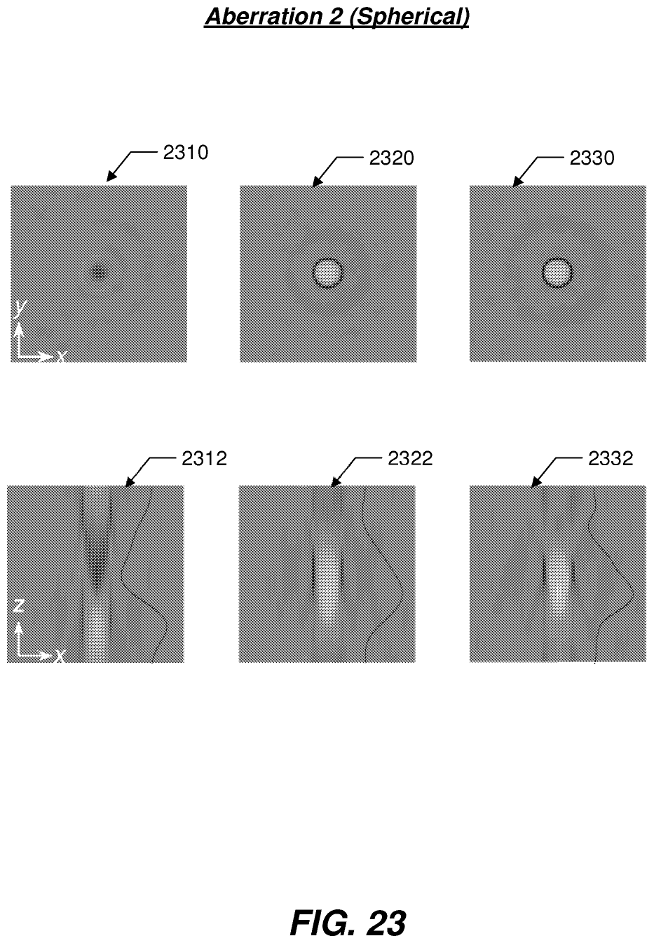

FIG. 23 includes experimentally-derived (spherically-dominant aberration) 3D-RI AFP images 2310, 2312 of a 6-μm polystyrene bead in the x-y view and x-z view without aberration correction, experimentally-derived 3D-RI AFP images 2320, 2322 of the 6-μm polystyrene bead in the x-y view and x-z view with aberration correction, and experimentally-derived 3D-RI AFP images 2330, 2332 of the 6-μm polystyrene bead in the x-y view and x-z view with darkfield extension. In this experiment, the system aberration was based on an invertedly placed sample inducing spherical dominant aberration.

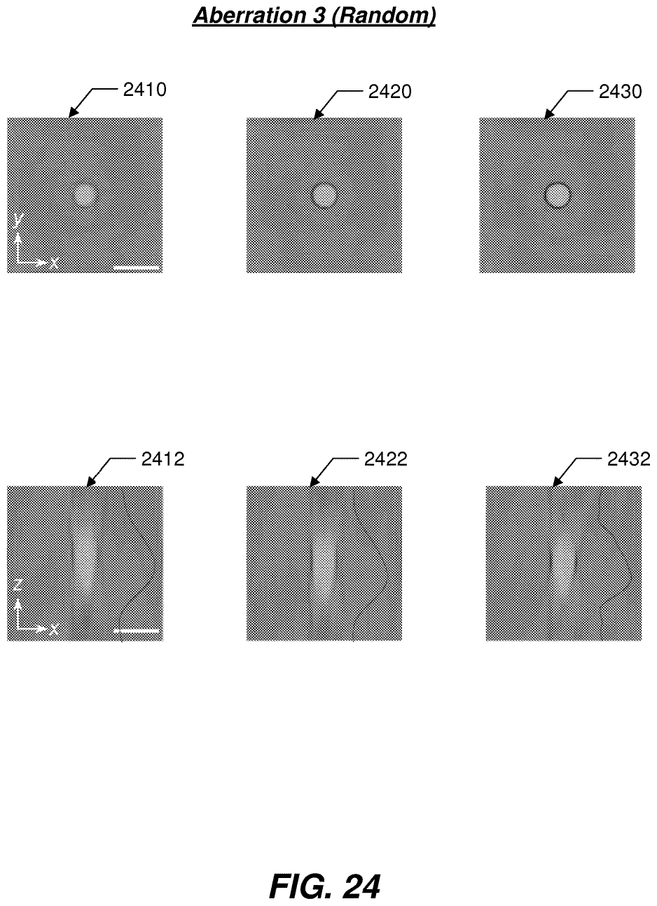

FIG. 24 includes experimentally-derived (random aberration) 3D-RI AFP images 2410, 2412 of a 6-μm polystyrene bead in the x-y view and x-z view without aberration correction, experimentally-derived 3D-RI AFP images 2420, 2422 of the 6-μm polystyrene bead in the x-y view and x-z view with aberration correction, and experimentally-derived 3D-RI AFP images 2430, 2432 of the 6-μm polystyrene bead in the x-y view and x-z view with darkfield extension. In this experiment, a random system aberration was induced by a piece of scotch tape placed close to the pupil plane of the objective lens.

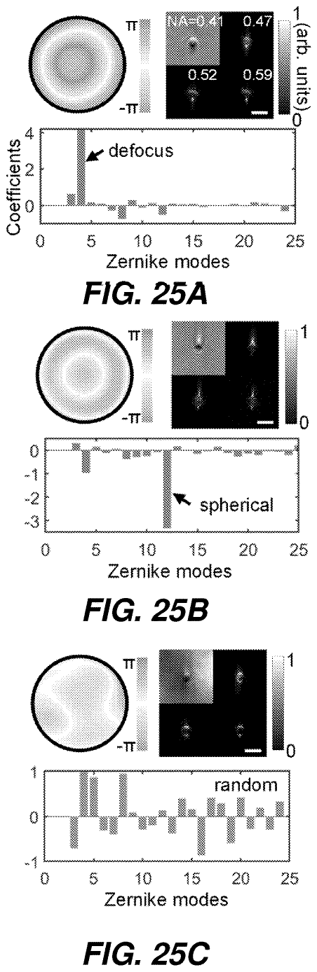

FIG. 25A includes pupil function and Zernike decompositions from AFP reconstruction for the defocus system aberration depicted in FIG. 22. FIG. 25B includes pupil function and Zernike decompositions from AFP reconstruction for the spherically-dominant system aberration depicted in FIG. 23. FIG. 25C includes pupil function and Zernike decompositions from AFP reconstruction for the random system aberration depicted in FIG. 24.

As shown in the illustrations shown in FIGS. 23-24, the reconstructions experimentally demonstrate AFP's effective aberration correction. The AFP imaging method was demonstrated to correct both single Zernike term dominant aberrations as shown in FIGS. 25A and 25B and more complex aberrations as shown in FIGS. 25A and 25C. For example, the AFP method corrected the defocus-dominant aberration with a maximal phase difference of 2.3π experimentally. Due to the missing cone problem that arises from information loss in z-axis of the 3D Fourier spectrum, the x-z sectional profiles appeared elongated rather than perfectly round. However, with analytic darkfield extension, the AFP method reduced axial elongation for all aberrations and improved the axial resolution as shown in the illustrations 2210, 2212, 2220, 2222, 2230, 2232 of FIG. 21, illustrations 2310, 2320, 2330, 2312, 2322, 2332 of FIG. 23, and illustrations 2410, 2420, 2430, 2412, 2422, and 2432 of FIG. 24. The 3D spectrum extension was further validated through spectrum visualization, where characteristic ring-shaped structures of the bead spectrum were clearly observed as shown in the illustrations 2240 and 2242 of FIG. 22.

### Label-Free Tomographic Imaging of Mouse Embryos

Embryos are optically transparent biological structures that serve as fundamental model organisms for studying early developmental processes, typically ranging from one to several hundred microns in size. Label-free volumetric imaging is crucial for studying and monitoring mouse and human embryo development, particularly in developmental biology and In Vitro Fertilization clinics. Compared to fluorescence microscopy, it minimizes phototoxicity, preserves natural embryo development, and provides high-resolution 3D information non-invasively. In mouse embryos, preimplantation development spans approximately five days, progressing from a single-cell zygote to the two-cell, four-cell, eight-cell, and ultimately the blastocyst stage. As the development advances, cellular divisions create increasingly sophisticated 3D structures.

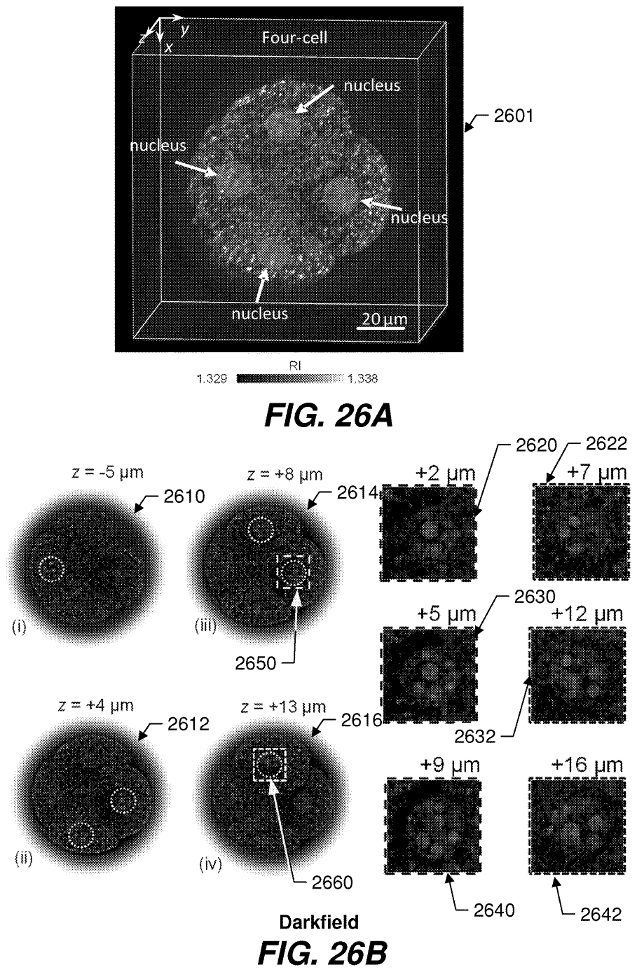

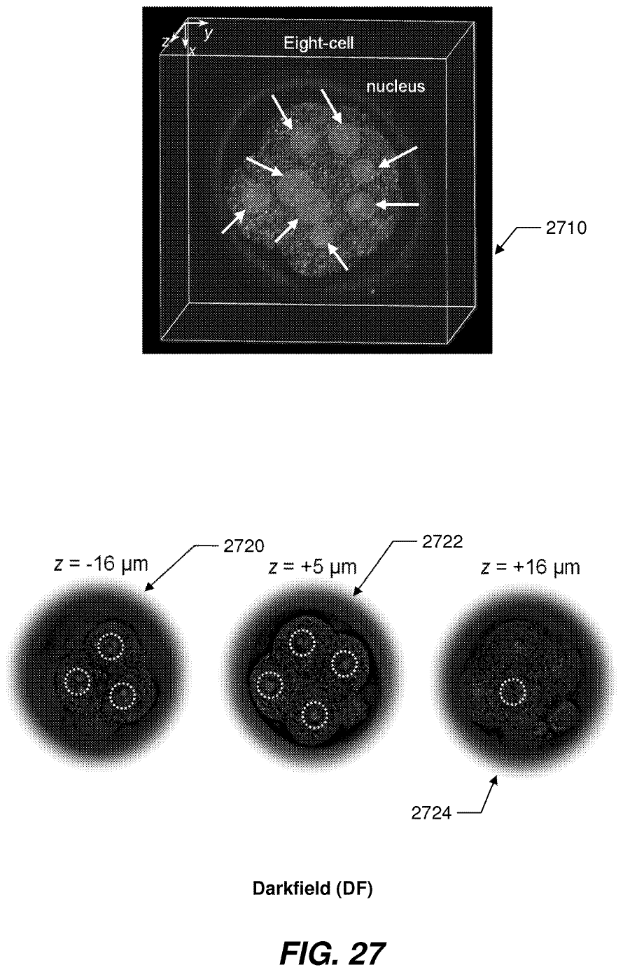

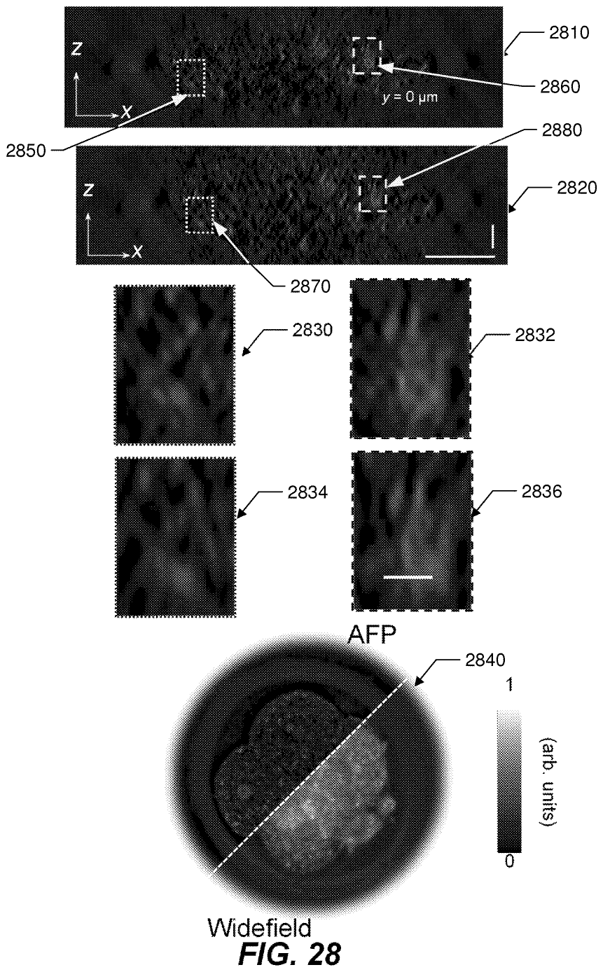

FIGS. 26A, 26B, 27, and 28 include experimental results of images from fixed mouse embryos at the four-cell and eight-cell stages acquired using the laser-based AFP system 700 shown in, and described with respect to, FIG. 7. FIG. 26A includes a 3D-RF AFP image 2601 of a four-cell stage embryo imaged with the laser-based AFP system 700. FIG. 26B includes visualizations of four z-slices 2610, 2612, 2614, and 2616 showing nucleoli within each embryonic cell, enlarged views 2620, 2630, and 2630 of region 2650 at distinct z-slices, and enlarged views 2622, 2632, and 2642 of region 2660 at distinct z-slices. FIG. 27 includes a 3D-RF AFP image 2701 of an eight-cell stage embryo imaged with the laser-based AFP system 700, visualizations of three z-slices 2720, 2722, and 2724 showing eight nuclei within each embryonic cell. FIG. 28 includes an illustration of a darkfield extended reconstruction 2810 and an illustration of an NA-matching reconstruction 2820 for comparison, enlarged view 2830 of region 2850, enlarged view 2832 of region 2860, enlarged view 2834 of region 2870, enlarged view 2836 of region 2880, and a visualization 2840 of a comparison between AFP imaging and absorption-based widefield microscope at z=+5 μm.

3D maximum intensity projection(MIP) renderings of whole embryos, with individual nucleus segmentations overlaid are shown in images 2601 and 2701. The quantitative RI reconstruction provides high-contrast visualization of the nuclear membrane boundary and nucleoli inside each cell, facilitating calculations of nucleus to cell boundary distance and the center of mass that are keys to evaluating embryo early development as shown in FIG. 26 FIGS. 26A and 26B. The 3D structure across multiple z-planes reveals the spatial distribution of nucleoli, which could aid nucleus tracking during the division processes. For the eight-cell stage embryo, the eight cells are distinctly distributed across different z-planes, with all eight nuclei clearly visible in three representative z-sections as shown in images 2720, 2722, and 2724. With darkfield extension, finer intracellular structures become more discernible as shown in the x-z sectional profile in images 2810 and 2820. As shown in visualization 2840, by comparing the AFP image of the eight-cell stage mouse embryo with the image from absorption-based widefield microscopy, the AFP method provides a clearer view of cell structures, particularly enabling a more comprehensive analysis of the nucleoli. In contrast, absorption-based microscopy suffers from low contrast in transparent samples, leading to information loss regarding the cell's internal features.

### Large FOV Plant Root and Bacteria Imaging

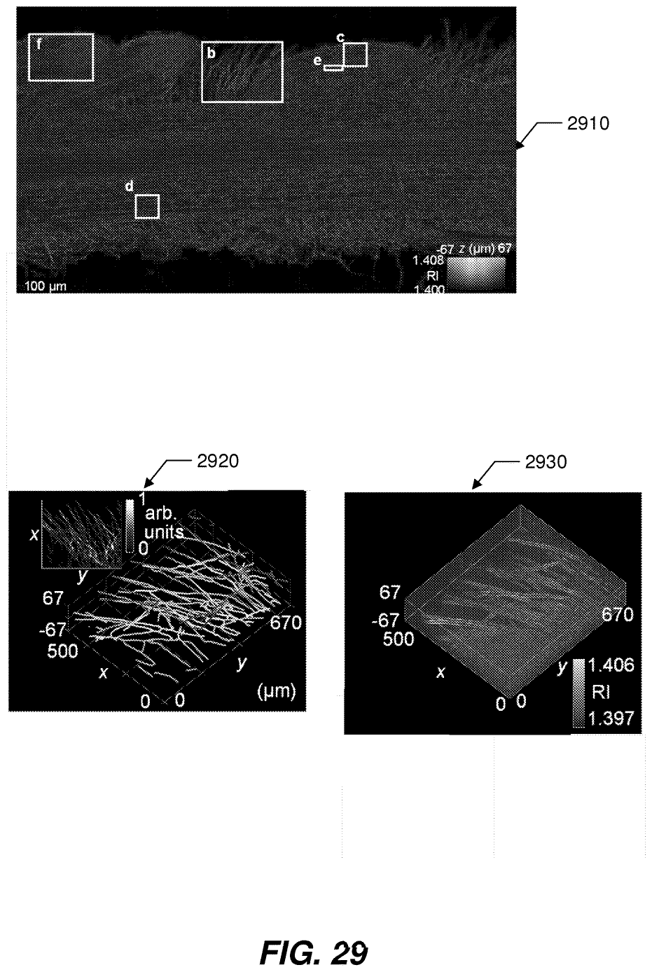

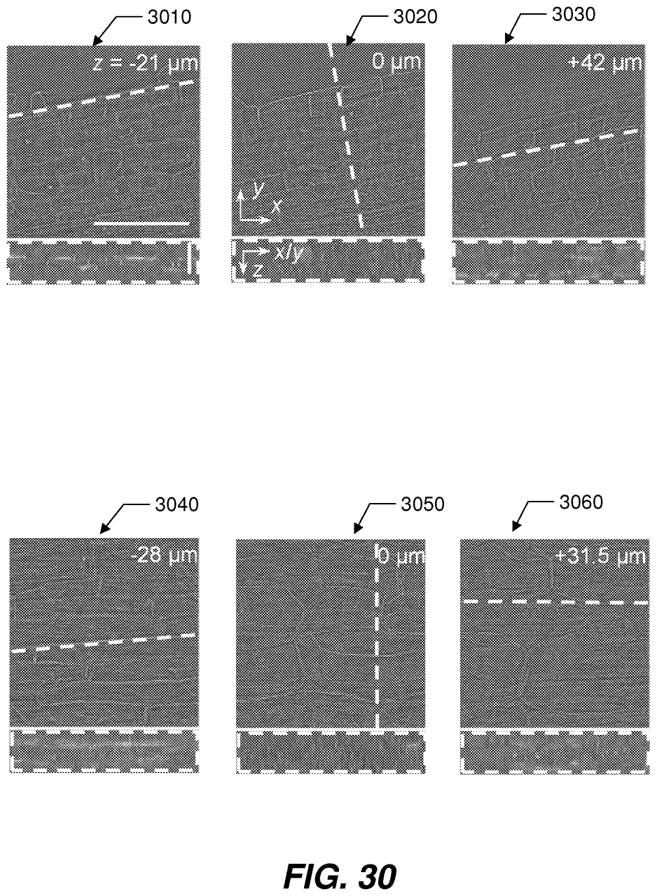

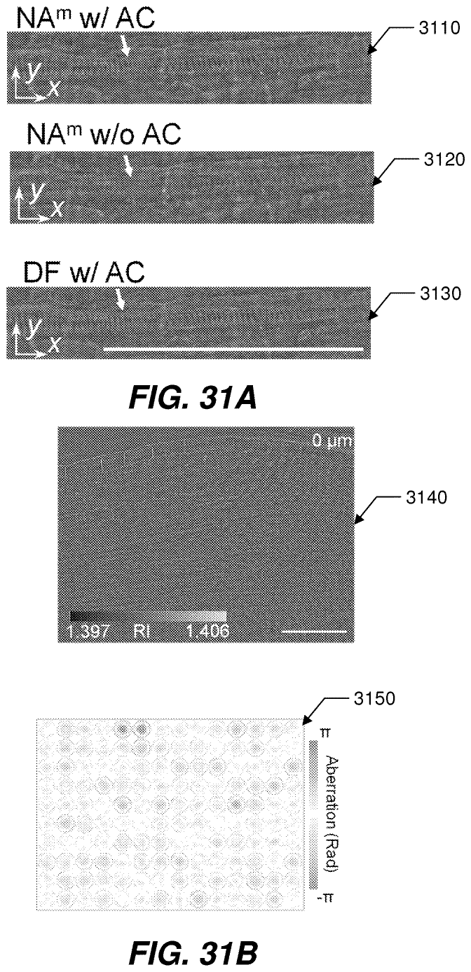

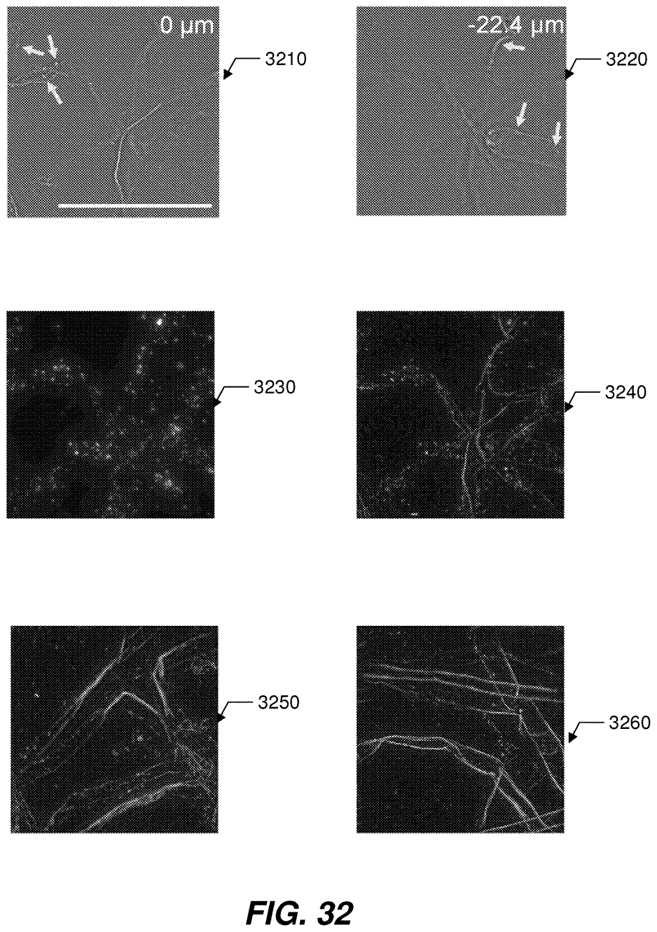

FIG. 29 depicts a maximum intensity projection(MIP) 2D image 2910 of a baby plant root tip of a 4.18×2.40×0.140 mm³ volume refractive index (RI) using AFP method with depth encoded in colors and RI encoded in image brightness, a 3D MIP rendering 2920 of root hair region in image 2910, and a 3D root skeleton image 2930 extracted from image 2920 and associated root hair density map. FIG. 30 depicts images of z-slices 3010, 3020, 3030, 3040, 3050, and 3060 of cellular structures from cortex regions in FIG. 29. FIG. 31A depicts images 3110, 3120, and 3130 of the baby plant root without aberration correction, with aberration correction, and with darkfield extension respectively. The darkfield extension image provides a clear structure of the stele region from the baby root tip. FIG. 31B depicts a visualization 3140 of field-dependent aberration correction for different patches of root structures, and visualization 3150 of retrieved aberrations. FIG. 32 depicts MIP images 3210, 3220 of coexistence of root hair and bacteria (as denoted by arrows) in a 1403 μm3 volume, MIP of fluorescence images 3230, 3240 for bacteria in the same FOV as MIP images 3210, 3220, and more FOVs 3250, 3260 for overlayed root hair.

The rhizosphere is a dynamic interface between plant roots and the soil microenvironment, where critical biological interactions occur. Visualizing root structure is essential for understanding root development, function, and interactions with the soil environment, with volumetric information providing crucial insights into root morphology, spatial organization, and root-soil interactions in three dimensions. The AFP method was implemented to provide RI reconstruction of a 7-day-old wheat root section (Triticum aestivum) over a 4.18×2.40×0.140 mm³ volume as shown in image 2910 in FIG. 29. The image was obtained using an LED-based AFP system (e.g., LED-based AFP system 200 in FIGS. 2A and 2B) with 48 NA-matching (illumination NA=0.40) and 288 darkfield illumination angles (synthetic NA=0.98). The RI distribution enables high-resolution visualization of various root structures. Root hairs, which facilitate water and nutrient uptake, appear as elongated cells as shown in visualizations 2920 and 2930 in FIG. 29. From the 3D-RI distribution, the root hair skeleton was extracted, allowing for spatial density and heterogeneity analysis as shown in FIG. 29. Additionally, epidermis, cortex and endodermis cells at the primary root or lateral root, layered around vascular bundle, are distinctly visualized as shown in FIG. 30. Despite the rich volumetric structural information, the aberration correction approach used by the AFP techniques effectively compensates for field-dependent aberrations, enabling the recovery of fine cellular and subcellular structures as shown in FIGS. 31A and 31B.

### Complex-Valued RI Imaging for 3D Digital Pathology

Digital pathology analysis has become a cornerstone in cancer diagnosis and patient treatments. Recent advancements in 3D digital pathology and deep learning suggest that the spatial volumetric information in histology can significantly enhance tumor grading and diagnosis. In certain embodiments, a DUV AFP system (e.g., rotating LED system 800 in FIG. 8 implementing DUV illumination) can operate to deliver illumination to the sample at a deep ultra-violet (DUV) wavelength for 3D label-free histologic imaging, eliminating variations from preanalytical sample preparation factors. The use of DUV is motivated by the strong absorption exhibited by nucleic acids at this wavelength.

Conventional histology relies on hematoxylin and eosin (H&E) stains to label the nucleic acids and extracellular matrix. However, H&E stains often require complex preparation procedures for thick tissue samples. Additionally, variability in the stain quality and color consistency poses challenges for deep learning-based analysis. To address these limitations, the DUV AFP system leverages complex-valued RI distributions at DUV wavelength to mimic H&E stain contrast.

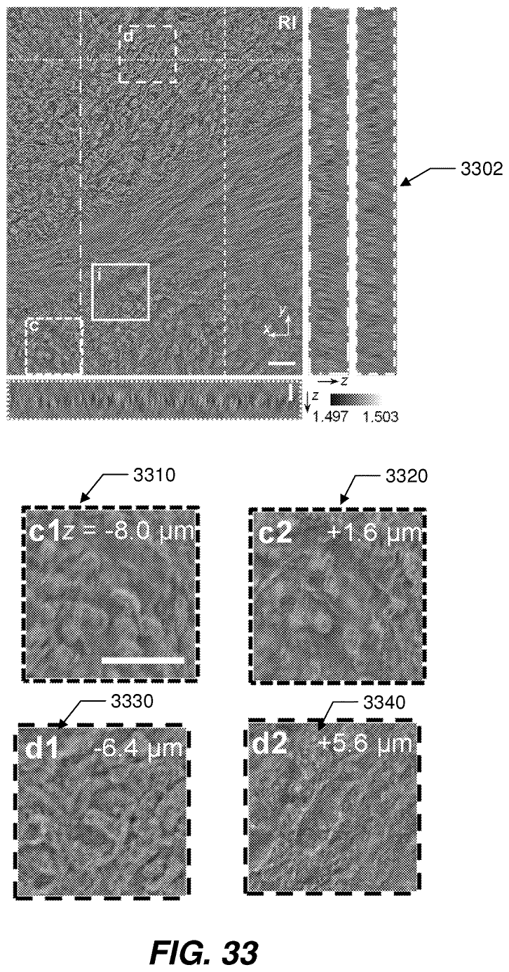

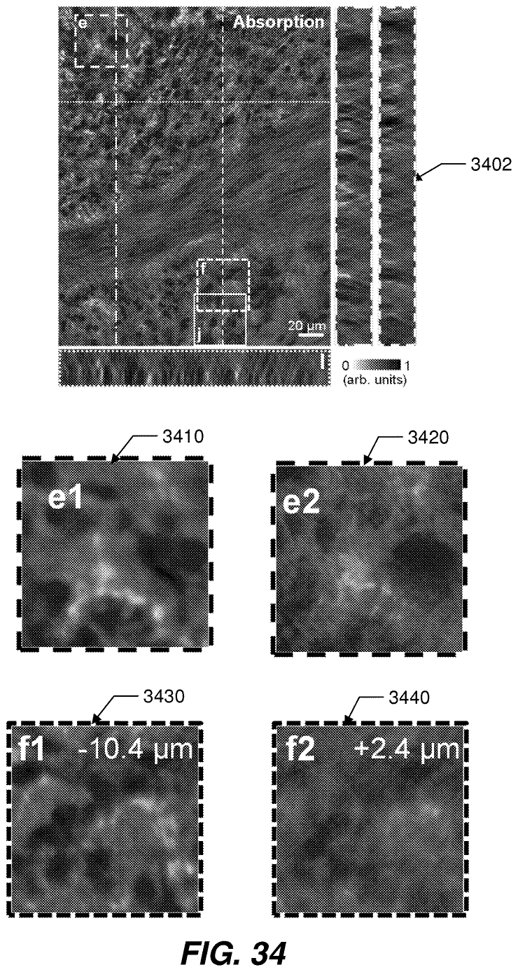

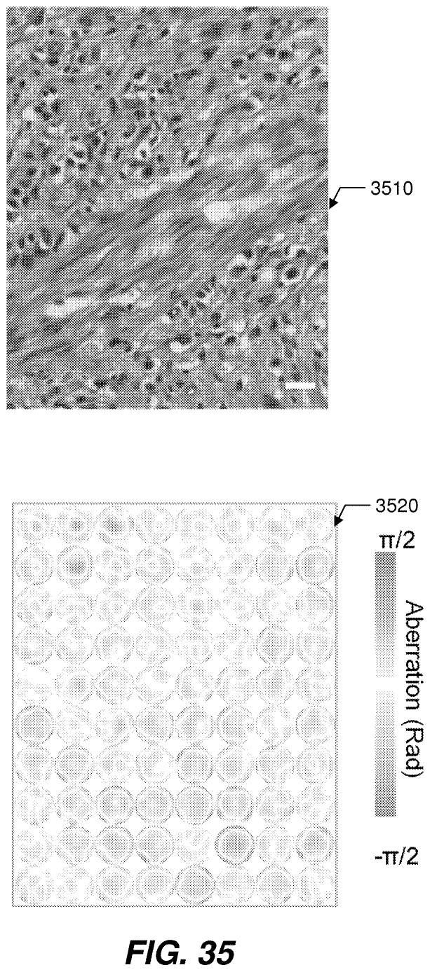

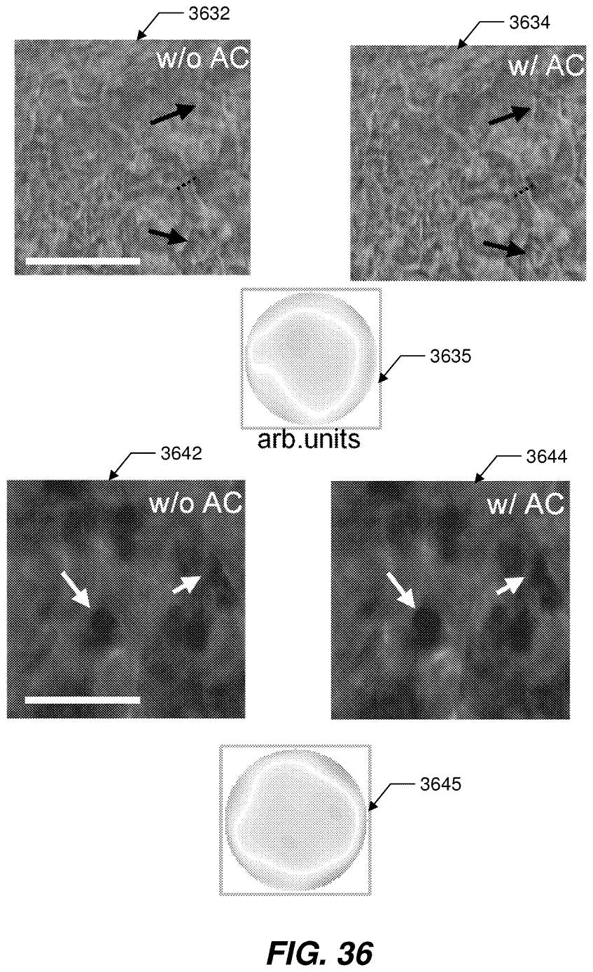

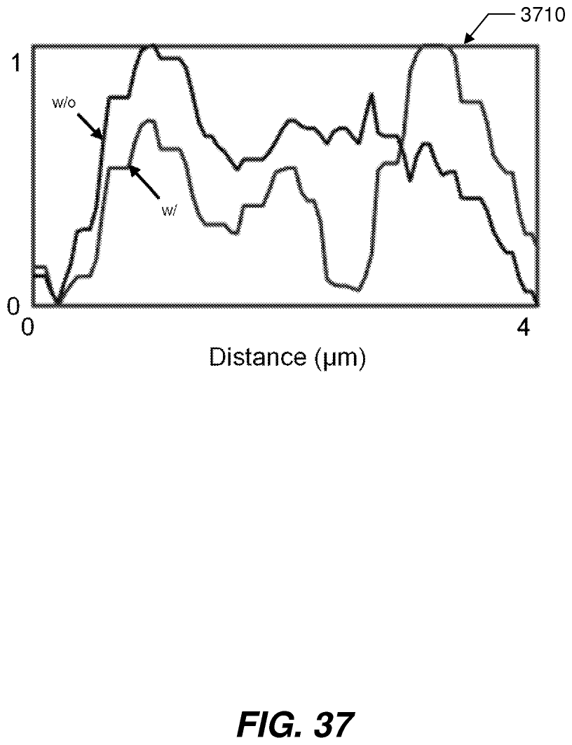

FIG. 33 depicts a z-slice image 3302 of the refractive index (RI) real part volume from the AFP method with x-z and y-z sections and zoomed in views 3310, 3320, 3330, and 3340. FIG. 34 depicts an absorption image 3402 correlating with the imaginary part of RI from AFP with associated x-z and y-z views, and zoomed in views 3410, 3420, 3430, and 3440. FIG. 35 depicts a widefield microscope image 3510 of an H&E-Stained adjacent thin cut and retrieved aberrations 3520 from 3410 and 3510, indicating effective field-dependent aberration correction. FIG. 36 depicts visualizations 3632, 3634, 3635, 3642, 3644, and 3645 of examples of image contrast improvements with aberration correction. FIG. 37 depicts a plot 3710 with a line profile comparison with and without aberration correction.

FIGS. 33-37 provide RI imaging of a 20-μm-thick human gastric adenocarcinoma section using DUV illumination at 265 nm with 48 NA-matching measurements. The real part of the RI distributions modifies the optical path length through the sample, reflecting variations in tissue composition and revealing intricate histologic features as shown in image 3302. The imaginary part of the RI distribution correlates with tissue absorptance, as nucleic acids strongly absorb light at 260-280 nm wavelengths due to x-electron transitions in aromatic bases. Consequently, the nuclear structures are clearly resolved in the absorption image 3402 effectively replicating the functionality of H-stain. Furthermore, other z-slices of the reconstructed complex-valued RI volume are presented in images 3310, 3320, 3330, 3340, 3410, 3420, 3430, and 3440. To directly compare DUV AFP with traditional H&E staining results, H&E-stained, 5-μm thin section from an adjacent cut was imaged under a 20×/0.40 NA widefield microscope providing microscope image 35z10. Additionally, dividing the entire FOV into small patches allowed for correction of field-dependent aberrations and enhanced image quality as shown in visualizations 2520, 3632, 3634, 3635, 3642, 3644, and 3645, and plot 3710. These results demonstrate AFP's ability to correct image blur caused by aberrations in real-world applications.

In various embodiments, AFP techniques can transform intensity measurements from multiple angular illuminations into aberration-corrected, complex-valued 3D-RI distributions. Unlike many other computational microscopy methods, AFP's analytic formulation eliminates the need for parameter tuning, making it highly robust and generalizable across different sample types and system configurations.

The versatility of AFP techniques of certain embodiments has been demonstrated by the experimental results by imaging various samples including polystyrene beads, mouse embryos, wheat roots and human gastric tissues and implementing various illumination sources such as lasers and LEDs spanning visible to DUV wavelengths. Further, AFP systems of certain embodiments have been demonstrated to extend the resolution beyond the NA of the objective lens through linear 3D spectrum extension, while preserving long working distances when using low-magnification objective lenses. These features make AFP techniques widely applicable for imaging large samples at high resolution.

The ability of AFP techniques to map 3D-RI distribution make it well-suited for quantitative analysis of weak scattering microscopic samples, offering unparalleled insights into biological and clinical studies. For instance, embryo imaging using AFP techniques highlights the potential in providing detailed insights into cell morphology, size, location, dry mass, and structural organization. Additionally, AFP techniques are suited for visualization of root structures mixed with rhizosphere bacteria and aligns excellently with fluorescence imaging, yet without the inherent limitations of fluorescence methods such as photobleaching. Further, DUV AFP imaging of pathology slides provides volumetric images that are independent of staining processes, which can vary across different sample preparation facilities and stain concentrations for conventional histology.

In one embodiment, AFP techniques can be used for live cell and organoid imaging, because of its rapid data acquisition and robust image reconstruction advantages.

In some embodiments, an AFP system may use parallel computing with two CPUs and four GPUs reduce this processing time to. In some cases, the AFP system may implement PyTorch, which may improve computational efficiency via programming.

AFP system's simple hardware design and robust algorithm will catalyze high-throughput applications for volumetric RI imaging across various fields, including cell biology, in vitro embryo development study, 3D digital pathology, tissue engineering, and plant science. Moreover, the label-free and quantitative imaging capabilities will facilitate biological and clinical data analysis, particularly in the context of machine learning and deep learning.

### IV. Computational Systems

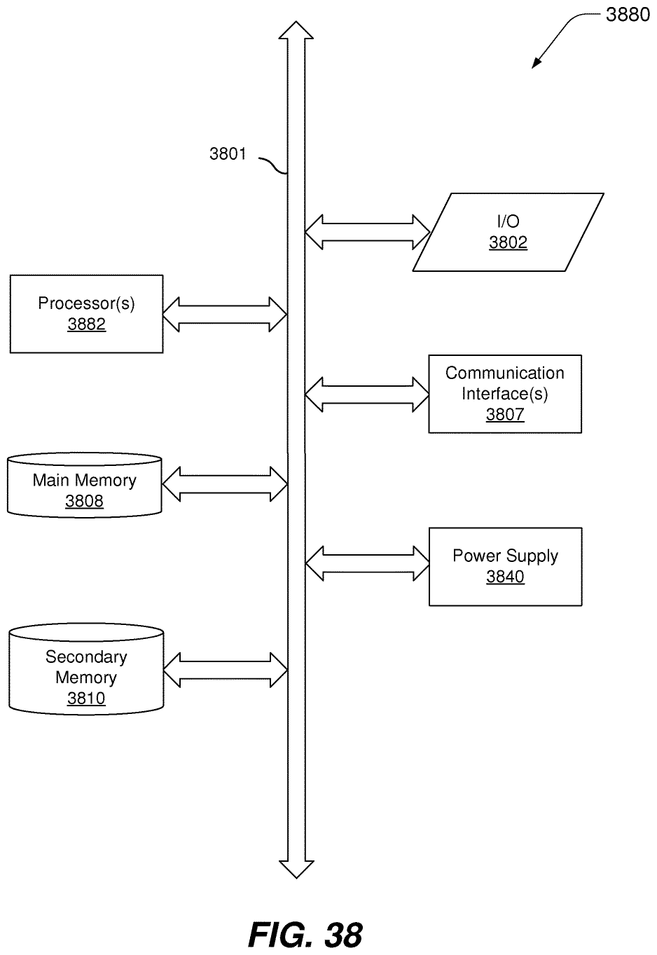

The AFP methods described above may be implemented using one or more computing devices. FIGS. 38 and 39 illustrate examples of computing devices that may be used, e.g., to implement functions of AFP methods described herein.

In FIG. 38, the computing device(s) 3880 includes a bus 3801 coupled to an input/output (I/O) subsystem 3802, one or more processors 3882, one or more communication interfaces 3807, a main memory 3808, a secondary memory 3810, and a power supply 3840. One or more of these components may be in separate housing. According to certain implementations, the illustrated components may be examples of components that are part of computing device(s) 190 in FIG. 1, computing device(s) 290 in FIGS. 2A and 2B, or computing device(s) 790 in FIG. 7, or computing device(s) 890 in FIG. 8. Computing device 3880 includes I/O subsystem 3802, which includes, or is in communication with, one or more components which may implement an interface for interacting with human users and/or other computer devices depending upon the application.

Certain embodiments disclosed herein may be implemented in program code on computing device 3880 with I/O subsystem 3802 used to receive input program statements and/or data from a human user (e.g., via a graphical user interface (GUI), a keyboard, touchpad, etc.) and to display them back to the user, for example, on a display. The I/O subsystem 3802 may include, e.g., a keyboard, mouse, graphical user interface, touchscreen, or other interfaces for input, and, e.g., an LED or other flat screen display, or other interfaces for output. Other elements of embodiments may be implemented with a computer system like that of computer system 3800 without I/O subsystem 3802. According to various embodiments, a processor may include a CPU, GPU or computer, analog and/or digital input/output connections, controller boards, etc.

Program code may be stored in non-transitory computer readable media such as secondary memory 3810 or main memory 3808 or both. One or more processors 3804 may read program code from one or more non-transitory media and execute the code to enable computing device 3880 to accomplish the methods performed by various embodiments described herein, such as AFP imaging methods. Those skilled in the art will understand that the one or more processors 3882 may accept source code and interpret or compile the source code into machine code that is understandable at the hardware gate level of the one or more processors 3882.

Communication interfaces 3807 may include any suitable components or circuitry used for communication using any suitable communication network (e.g., the Internet, an intranet, a wide-area network (WAN), a local-area network (LAN), a wireless network, a virtual private network (VPN), and/or any other suitable type of communication network). For example, communication interfaces 3807 can include network interface card circuitry, wireless communication circuitry, etc.

In certain embodiments, computing device 3880 may be part of or connected to a controller that is employed to control functions of various system components described herein. For example, computing device 3880 may control recording of signals by a polarized camera and/or delivery of energy by at least one energy source. The controller will typically include one or more memory devices and one or more processors. The processor may include a CPU or computer, analog and/or digital input/output connections, stepper motor controller boards, etc.

In FIG. 39, the computing device(s) 3950 includes one or more processors 3960 (e.g., microprocessors), a non-transitory computer readable medium (CRM) 3970 in communication with the processor(s) 3960, and one or more displays 3980 also in communication with processor(s) 3960. Processor(s) 3960 is in electronic communication with CRM 3970 (e.g., memory). Processor(s) 3960 is also in electronic communication with display(s) 3980, e.g., to display image data, text, etc. on display 3980. Processor(s) 3960 may retrieve and execute instructions stored on the CRM 3970 to perform one or more functions described above. For example, processor(s) 3960 may execute instructions to perform one or more operations to acquire raw images, reconstruct volumetric fluorescence images, etc. The CRM (e.g., memory) 3970 can store instructions for performing one or more functions of the described above. These instructions may be executable by processor(s) 3960. CRM 3970 can also store raw images, e.g., microscopy images, polarized sub-images from a raw image, or the like.

Many types of computing devices having any of various computer architectures may be employed as the disclosed systems for implementing algorithms. For example, the computing devices may include software components executing on one or more general purpose processors or specially designed processors such as Application Specific Integrated Circuits (ASICs) or programmable logic devices (e.g., Field Programmable Gate Arrays (FPGAs)). Further, the systems may be implemented on a single device or distributed across multiple devices. The functions of the computational elements may be merged into one another or further split into multiple sub-modules.

At one level a software element is implemented as a set of commands prepared by the programmer/developer. However, the module software that can be executed by the computer hardware is executable code committed to memory using “machine codes” selected from the specific machine language instruction set, or “native instructions,” designed into the hardware processor. The machine language instruction set, or native instruction set, is known to, and essentially built into, the hardware processor(s). This is the “language” by which the system and application software communicates with the hardware processors. Each native instruction is a discrete code that is recognized by the processing architecture and that can specify particular registers for arithmetic, addressing, or control functions; particular memory locations or offsets; and particular addressing modes used to interpret operands. More complex operations are built up by combining these simple native instructions, which are executed sequentially, or as otherwise directed by control flow instructions.

The inter-relationship between the executable software instructions and the hardware processor is structural. In other words, the instructions per se are a series of symbols or numeric values. They do not intrinsically convey any information. It is the processor, which by design was preconfigured to interpret the symbols/numeric values, which imparts meaning to the instructions.

The algorithms used herein may be configured to execute on a single machine at a single location, on multiple machines at a single location, or on multiple machines at multiple locations. When multiple machines are employed, the individual machines may be tailored for their particular tasks. For example, operations requiring large blocks of code and/or significant processing capacity may be implemented on large and/or stationary machines.

In addition, certain embodiments relate to tangible and/or non-transitory computer readable media or computer program products that include program instructions and/or data (including data structures) for performing various computer-implemented operations. Examples of computer-readable media include, but are not limited to, memory devices, phase-change devices, magnetic media such as disk drives, magnetic tape, optical media such as CDS, magneto-optical media, and hardware devices that are specially configured to store and perform program instructions, such as read-only memory devices (ROM) and random access memory (RAM). The computer readable media may be directly controlled by an end user or the media may be indirectly controlled by the end user. Examples of directly controlled media include the media located at a user facility and/or media that are not shared with other entities. Examples of indirectly controlled media include media that is indirectly accessible to the user via an external network and/or via a service providing shared resources such as the “cloud.” Examples of program instructions include both machine code, such as produced by a compiler, and files containing higher level code that may be executed by the computer using an interpreter.

In some embodiments, code executed during generation or execution of various models on an appropriately programmed system can be embodied in the form of software elements which can be stored in a nonvolatile storage medium (such as optical disk, flash storage device, mobile hard disk, etc.), including a number of instructions for making a computing device (such as personal computers, servers, network equipment, etc.). In various embodiments, the data or information employed in the disclosed methods and apparatus is provided in an electronic format. Such data or information may include design layouts, fixed parameter values, floated parameter values, feature profiles, metrology results, and the like. As used herein, data or other information provided in electronic format is available for storage on a machine and transmission between machines. Conventionally, data in electronic format is provided digitally and may be stored as bits and/or bytes in various data structures, lists, databases, etc. The data may be embodied electronically, optically, etc.

### EXAMPLE EMBODIMENTS

Embodiment 1: An analytic Fourier ptychotomography imaging method, comprising: obtaining a plurality of NA-matching intensity measurements corresponding to plurality of NA-matching illumination angles and a plurality of darkfield intensity measurements corresponding to a plurality of darkfield illumination angles; determining an aberration-corrected NA-matching spectrum based at least in part on the plurality of NA-matching intensity measurements and a finite sample thickness (FST) prior; extending the aberration-corrected NA-matching spectrum using the plurality of darkfield intensity measurements; and reconstructing a volumetric refractive index distribution of a sample being imaged based at least in part on the extended aberration-corrected NA-matching spectrum.

Embodiment 2: The analytic Fourier ptychotomography imaging method of embodiment 1, wherein determining the aberration-corrected NA-matching spectrum comprises: recovering a plurality of NA-matching sub-spectrums from NA-matching intensity measurements using Kramers-Kronig (K-K) relation; solving for system aberration using a finite sample thickness (FST) prior; removing the system aberration from each of the NA-matching sub-spectrums to form a plurality of aberration-corrected NA-matching sub-spectrums; and stitching together the plurality of aberration-corrected NA-matching sub-spectrums to form an aberration-corrected NA-matching sample spectrum.

Embodiment 3: The analytic Fourier ptychotomography imaging method of embodiment 2, wherein recovering the plurality of NA-matching sub-spectrums comprises: for each NA-matching illumination angle, determining a 2D complex-valued Fourier spectrum from a corresponding NA-matching measurement using Kronig-Kramer relation to generate a plurality of 2D complex-valued Fourier spectrums; and mapping each of the 2D complex-valued Fourier spectrums onto an Ewald space to form a plurality of NA-matching sub-spectrums.

Embodiment 4: The analytic Fourier ptychotomography imaging method of embodiment 1, further comprising determining the FST prior based on thickness of the sample being imaged.

Embodiment 5: The analytic Fourier ptychotomography imaging method of embodiment 2, wherein solving for system aberration using the finite sample thickness (FST) prior comprises: determining the FST prior based on thickness of the sample being imaged; pairing the plurality of NA-matching sub-spectrums to from a plurality of sub-spectrum pairs; using the FST prior to extend an overlap region between each of the sub-spectrum pairs; using positions of the extended overlap regions to form a position matrix; subtracting phase of each of the sub-spectrum pairs within the extended overlap regions to generate a plurality of phase difference vectors; and using the position matrix and phase difference vectors to form a set of linear equations; solving for system aberration from the set of linear equations using least square solution.

Embodiment 6: The analytic Fourier ptychotomography imaging method of embodiment 1, wherein extending the aberration-corrected NA-matching spectrum comprises: for each darkfield illumination angle, extracting a known component of the aberration-corrected NA-matching sample spectrum; constructing a cross-correlation operator from the known components; using the cross-correlation operator to form a set of linear equations based on the known components; solving for unknown components with the set of linear equations using least squares relation to generate a plurality of darkfield sub-spectrums using least square solution; and ptychographically synthesizing darkfield sub-spectrums with NA-matching sub-spectrums to generate a darkfield-extended sample spectrum.

Embodiment 7A: The analytic Fourier ptychotomography imaging method of embodiment 1, wherein reconstructing the volumetric refractive index distribution comprises: applying inverse Fourier transform to the darkfield extended spectrum; and applying linear transform to reconstruct the volumetric refractive index distribution.

Embodiment 7B: The analytic Fourier ptychotomography imaging method of embodiment 1, wherein obtaining the plurality of NA-matching intensity measurements and the plurality of darkfield intensity measurements comprises causing an illumination source to deliver to the sample NA-matching illumination at the plurality of NA-matching illumination angles and darkfield illumination at the plurality of darkfield illumination angles.

Embodiment 8: An analytic Fourier ptychotomography imaging system, comprising an illumination system configured to provide illumination at a plurality of NA-matching illumination angles and at a plurality of darkfield illumination angles to a sample being imaged; an optical system comprising collection optics configured to collect light scattered by a sample being illuminated, wherein the NA-matching illumination angles are equal to, or nearly equal to, an acceptance angle of the collection optics and the darkfield illumination angles are greater than the acceptance angle of the collection optics; one or more light detectors in optical communication with the optical system, the one or more light detectors configured to acquire (i) a plurality of NA-matching intensity measurements corresponding to the NA-matching illumination angles and (i) a plurality of darkfield measurements corresponding to the darkfield illumination angles; and a computing device configured to reconstruct a volumetric refractive index distribution based at least in part on the plurality of NA-matching intensity measurements and the plurality of darkfield measurements.

Embodiment 9: The analytic Fourier ptychotomography imaging system of embodiment 8, wherein the computing device is configured to reconstruct the volumetric refractive index distribution by: obtaining a plurality of NA-matching intensity measurements corresponding to plurality of NA-matching illumination angles and a plurality of darkfield intensity measurements corresponding to a plurality of darkfield illumination angles; determining an aberration-corrected NA-matching spectrum based at least in part on the plurality of NA-matching intensity measurements and a finite sample thickness (FST) prior; extending the aberration-corrected NA-matching spectrum using the plurality of darkfield intensity measurements; and reconstructing the volumetric refractive index distribution based at least in part on the extended aberration-corrected NA-matching spectrum.

Embodiment 10: The analytic Fourier ptychotomography imaging system of embodiment 9, wherein the computing device is configured to determine the aberration-corrected NA-matching spectrum by: recovering a plurality of NA-matching sub-spectrums from NA-matching intensity measurements using Kramers-Kronig (K-K) relation; solving for system aberration using a finite sample thickness (FST) prior; removing the system aberration from each of the NA-matching sub-spectrums to form a plurality of aberration-corrected NA-matching sub-spectrums; and stitching together the plurality of aberration-corrected NA-matching sub-spectrums to form an aberration-corrected NA-matching sample spectrum.

Embodiment 11: The analytic Fourier ptychotomography imaging system of embodiment 8, wherein the illumination system comprises one or more light emitting diodes (LEDs).

Embodiment 12: The analytic Fourier ptychotomography imaging system of embodiment 8, wherein the illumination system comprises a circular or rectangular array of light emitting diodes (LEDs).

Embodiment 13: The analytic Fourier ptychotomography imaging system of embodiment 8, wherein the illumination system comprises a circular array of light emitting diodes (LEDs), the circular array comprising a ring of NA matching illumination sources configured to provide illumination at the plurality of NA-matching illumination angles.

Embodiment 14: The analytic Fourier ptychotomography imaging system of embodiment 8, wherein the illumination system comprises at least one laser source and a rotational mechanism configured rotate a laser beam from at least one laser source such that the laser beam is provided sequentially at the plurality of NA-matching illumination angles and the plurality of darkfield illumination angles.

Embodiment 15: The analytic Fourier ptychotomography imaging system of embodiment 14, wherein the rotational mechanism is a galvo mirror.

Embodiment 16: The analytic Fourier ptychotomography imaging system of embodiment 8, wherein the illumination system comprises: a rotational mechanism; and an illumination source mounted to the rotational mechanism.

Embodiment 17: The analytic Fourier ptychotomography imaging system of embodiment 16, wherein the rotational mechanism is a rotational stage.

Embodiment 18: A non-transitory machine-readable medium comprising instructions that, when executed by one or more processors, are configured to cause the one or more processors to perform operations comprising: obtaining a plurality of NA-matching intensity measurements corresponding to plurality of NA-matching illumination angles and a plurality of darkfield intensity measurements corresponding to a plurality of darkfield illumination angles; determining an aberration-corrected NA-matching spectrum based at least in part on the plurality of NA-matching intensity measurements and a finite sample thickness (FST) prior; extending the aberration-corrected NA-matching spectrum using the plurality of darkfield intensity measurements; and reconstructing a volumetric refractive index distribution based at least in part on the extended aberration-corrected NA-matching spectrum.

Embodiment 19: The non-transitory machine-readable medium of embodiment 18, wherein determining the aberration-corrected NA-matching spectrum comprises: recovering a plurality of NA-matching sub-spectrums from NA-matching intensity measurements using Kramers-Kronig (K-K) relation; solving for system aberration using a finite sample thickness (FST) prior; removing the system aberration from each of the NA-matching sub-spectrums to form a plurality of aberration-corrected NA-matching sub-spectrums; and stitching together the plurality of aberration-corrected NA-matching sub-spectrums to form an aberration-corrected NA-matching sample spectrum.

Embodiment 20: The analytic Fourier ptychotomography imaging system of embodiment 18, further comprising determining the FST prior based on thickness of a sample being imaged.

Modifications, additions, or omissions may be made to any of the above-described embodiments without departing from the scope of the disclosure. Any of the embodiments described above may include more, fewer, or other features without departing from the scope of the disclosure. Additionally, the steps of described features may be performed in any suitable order without departing from the scope of the disclosure. Also, one or more features from any embodiment may be combined with one or more features of any other embodiment without departing from the scope of the disclosure. The components of any embodiment may be integrated or separated according to particular needs without departing from the scope of the disclosure.

It should be understood that certain aspects described above can be implemented in the form of logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code using any suitable computer language and/or computational software such as, for example, Java, C, C#, C++ or Python, Lab VIEW, Mathematica, or other suitable language/computational software, including low level code, including code written for field programmable gate arrays, for example in VHDL. The code may include software libraries for functions like data acquisition and control, motion control, image acquisition and display, etc. Some or all of the code may also run on a personal computer, single board computer, embedded controller, microcontroller, digital signal processor, field programmable gate array and/or any combination thereof or any similar computation device and/or logic device(s). The software code may be stored as a series of instructions, or commands on a CRM such as a random access memory (RAM), a read only memory (ROM), a magnetic media such as a hard-drive or a floppy disk, or an optical media such as a CD-ROM, or solid state storage such as a solid state hard drive or removable flash memory device or any suitable storage device. Any such CRM may reside on or within a single computational apparatus, and may be present on or within different computational apparatuses within a system or network. Although the foregoing disclosed embodiments have been described in some detail to facilitate understanding, the described embodiments are to be considered illustrative and not limiting. It will be apparent to one of ordinary skill in the art that certain changes and modifications can be practiced within the scope of the appended claims.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

What is claimed is:

1. An analytic Fourier ptychotomography imaging method, comprising:
obtaining a plurality of NA-matching intensity measurements corresponding to plurality of NA-matching illumination angles and a plurality of darkfield intensity measurements corresponding to a plurality of darkfield illumination angles;
determining an aberration-corrected NA-matching spectrum based at least in part on the plurality of NA-matching intensity measurements and a finite sample thickness (FST) prior;
extending the aberration-corrected NA-matching spectrum using the plurality of darkfield intensity measurements; and
reconstructing a volumetric refractive index distribution of a sample being imaged based at least in part on the extended aberration-corrected NA-matching spectrum.

2. The analytic Fourier ptychotomography imaging method of claim, wherein determining the aberration-corrected NA-matching spectrum comprises:
recovering a plurality of NA-matching sub-spectrums from NA-matching intensity measurements using Kramers-Kronig (K-K) relation;
solving for system aberration using a finite sample thickness (FST) prior;
removing the system aberration from each of the NA-matching sub-spectrums to form a plurality of aberration-corrected NA-matching sub-spectrums; and
stitching together the plurality of aberration-corrected NA-matching sub-spectrums to form an aberration-corrected NA-matching sample spectrum.

3. The analytic Fourier ptychotomography imaging method of claim, wherein recovering the plurality of NA-matching sub-spectrums comprises:
for each NA-matching illumination angle, determining a 2D complex-valued Fourier spectrum from a corresponding NA-matching measurement using Kronig-Kramer relation to generate a plurality of 2D complex-valued Fourier spectrums; and
mapping each of the 2D complex-valued Fourier spectrums onto an Ewald space to form a plurality of NA-matching sub-spectrums.

4. The analytic Fourier ptychotomography imaging method of claim, further comprising determining the FST prior based on thickness of the sample being imaged.

5. The analytic Fourier ptychotomography imaging method of claim, wherein solving for system aberration using the finite sample thickness (FST) prior comprises:
determining the FST prior based on thickness of the sample being imaged;
pairing the plurality of NA-matching sub-spectrums to from a plurality of sub-spectrum pairs;
using the FST prior to extend an overlap region between each of the sub-spectrum pairs;
using positions of the extended overlap regions to form a position matrix;
subtracting phase of each of the sub-spectrum pairs within the extended overlap regions to generate a plurality of phase difference vectors;
using the position matrix and phase difference vectors to form a set of linear equations; and
solving for system aberration from the set of linear equations using least square solution.

6. The analytic Fourier ptychotomography imaging method of claim, wherein extending the aberration-corrected NA-matching spectrum comprises:
for each darkfield illumination angle, extracting a known component of the aberration-corrected NA-matching sample spectrum;
constructing a cross-correlation operator from the known components;
using the cross-correlation operator to form a set of linear equations based on the known components;
solving for unknown components with the set of linear equations using least squares relation to generate a plurality of darkfield sub-spectrums using least square solution; and
ptychographically synthesizing darkfield sub-spectrums with NA-matching sub-spectrums to generate a darkfield-extended sample spectrum.

7. The analytic Fourier ptychotomography imaging method of claim, wherein reconstructing the volumetric refractive index distribution comprises:
applying inverse Fourier transform to the darkfield extended spectrum; and
applying linear transform to reconstruct the volumetric refractive index distribution.

8. The analytic Fourier ptychotomography imaging method of claim, wherein obtaining the plurality of NA-matching intensity measurements and the plurality of darkfield intensity measurements comprises causing an illumination source to deliver to the sample NA-matching illumination at the plurality of NA-matching illumination angles and darkfield illumination at the plurality of darkfield illumination angles.

9. An analytic Fourier ptychotomography imaging system, comprising:
an illumination system configured to provide NA-matching illumination at a plurality of NA-matching illumination angles and darkfield illumination at a plurality of darkfield illumination angles to a sample being imaged;
an optical system comprising collection optics configured to collect light scattered by a sample being illuminated, wherein the NA-matching illumination angles are equal to, or nearly equal to, an acceptance angle of the collection optics and the darkfield illumination angles are greater than the acceptance angle of the collection optics;
one or more light detectors in optical communication with the optical system, the one or more light detectors configured to acquire (i) a plurality of NA-matching intensity measurements corresponding to the NA-matching illumination angles and (i) a plurality of darkfield measurements corresponding to the darkfield illumination angles; and
a computing device configured to reconstruct a volumetric refractive index distribution based at least in part on the plurality of NA-matching intensity measurements and the plurality of darkfield measurements.

10. The analytic Fourier ptychotomography imaging system of claim, wherein the computing device is configured to reconstruct the volumetric refractive index distribution by:
obtaining a plurality of NA-matching intensity measurements corresponding to plurality of NA-matching illumination angles and a plurality of darkfield intensity measurements corresponding to a plurality of darkfield illumination angles;
determining an aberration-corrected NA-matching spectrum based at least in part on the plurality of NA-matching intensity measurements and a finite sample thickness (FST) prior;
extending the aberration-corrected NA-matching spectrum using the plurality of darkfield intensity measurements; and
reconstructing the volumetric refractive index distribution based at least in part on the extended aberration-corrected NA-matching spectrum.

11. The analytic Fourier ptychotomography imaging system of claim, wherein the computing device is configured to determine the aberration-corrected NA-matching spectrum by:
recovering a plurality of NA-matching sub-spectrums from NA-matching intensity measurements using Kramers-Kronig (K-K) relation;
solving for system aberration using a finite sample thickness (FST) prior;
removing the system aberration from each of the NA-matching sub-spectrums to form a plurality of aberration-corrected NA-matching sub-spectrums; and
stitching together the plurality of aberration-corrected NA-matching sub-spectrums to form an aberration-corrected NA-matching sample spectrum.

12. The analytic Fourier ptychotomography imaging system of claim, wherein the illumination system comprises one or more light emitting diodes (LEDs).

13. The analytic Fourier ptychotomography imaging system of claim, wherein the illumination system comprises a circular or rectangular array of light emitting diodes (LEDs).

14. The analytic Fourier ptychotomography imaging system of claim, wherein the illumination system comprises a circular array of light emitting diodes (LEDs), the circular array comprising a ring of NA matching illumination sources configured to provide illumination at the plurality of NA-matching illumination angles.

15. The analytic Fourier ptychotomography imaging system of claim, wherein the illumination system comprises at least one laser source and a rotational mechanism configured rotate a laser beam from at least one laser source such that the laser beam is provided sequentially at the plurality of NA-matching illumination angles and the plurality of darkfield illumination angles.

16. The analytic Fourier ptychotomography imaging system of claim, wherein the rotational mechanism is a galvo mirror.

17. The analytic Fourier ptychotomography imaging system of claim, wherein the illumination system comprises:
a rotational mechanism; and
an illumination source mounted to the rotational mechanism.

18. A non-transitory machine-readable medium comprising instructions that, when executed by one or more processors, are configured to cause the one or more processors to perform operations comprising:
obtaining a plurality of NA-matching intensity measurements corresponding to plurality of NA-matching illumination angles and a plurality of darkfield intensity measurements corresponding to a plurality of darkfield illumination angles;
determining an aberration-corrected NA-matching spectrum based at least in part on the plurality of NA-matching intensity measurements and a finite sample thickness (FST) prior;
extending the aberration-corrected NA-matching spectrum using the plurality of darkfield intensity measurements; and
reconstructing a volumetric refractive index distribution based at least in part on the extended aberration-corrected NA-matching spectrum.

19. The non-transitory machine-readable medium of claim, wherein determining the aberration-corrected NA-matching spectrum comprises:
recovering a plurality of NA-matching sub-spectrums from NA-matching intensity measurements using Kramers-Kronig (K-K) relation;
solving for system aberration using a finite sample thickness (FST) prior;
removing the system aberration from each of the NA-matching sub-spectrums to form a plurality of aberration-corrected NA-matching sub-spectrums; and
stitching together the plurality of aberration-corrected NA-matching sub-spectrums to form an aberration-corrected NA-matching sample spectrum.

20. The non-transitory machine-readable medium of claim, further comprising determining the FST prior based on thickness of a sample being imaged.
